(19) United States
(12) Patent Application Publication
(10) Pub. No.: US 2011/0257900 A1
(43) Pub. Date: Oct. 20, 2011

(54) METHODS AND APPARATUS FOR DIAGNOSING FAULTS OF A VEHICLE

(75) Inventors: Douglas E. Adams, West Lafayette, IN (US); Tiffany Lynn Di Petta, Rochester, MI (US); David Joseph Koester, Lafayette, IN (US); Grant A. Gordon, Peoria, AZ (US)

(73) Assignee: PURDUE RESEARCH FOUNDATION, West Lafayette, IN (US)

(21) Appl. No.: 13/120,218

(22) PCT Filed: Sep. 22, 2009
(86) PCT No.: PCT/US09/57919

§ 371 Date: Jul. 7, 2011

Related U.S. Application Data
(60) Provisional application No. 61/098,995, filed on Sep. 22, 2008.

(51) Int. Cl. G06F 19/00; G01M 17/007

(52) U.S. Cl. 702/33; 73/117.01

(57) ABSTRACT

A rubber cleat is instrumented with two triaxial accelerometers to measure the multi-directional response of the cleat due to the forces within the tire footprint of a ground vehicle. The cleat data is used to detect faults in the front and rear suspension in addition to the wheel tire despite variability in the data. This offboard diagnostic technique is proposed to enable condition-based maintenance.

### CROSS REFERENCE TO RELATED APPLICATION

This application claims the benefit of priority to U.S. Provisional Patent Application Ser. No. 61/098,995, filed Sep. 22, 2008, entitled INSTRUMENTED CLEAT, incorporated herein by reference.

### FIELD OF THE INVENTION

Various embodiments of the present invention pertain to methods and apparatus for determining a change in the condition of a vehicle, and in particular to the use of ground-based sensors for finding faults in a wheeled vehicle.

### BACKGROUND OF THE INVENTION

The U.S. Army is pursuing technologies that will enable Condition-Based Maintenance (CBM) of ground vehicles. Current maintenance schedules for ground vehicles are determined based on reliability predictions (e.g., mean time to failure) of a population of vehicles under anticipated operational loads; however, vehicles that experience component damage often lie in the tails of the reliability distribution for a given platform. For example, a certain group of vehicles may be deployed to operate on a harsh terrain that is particularly taxing on the mechanical components in the suspensions or frames of those vehicles. Operation & support costs for military weapon systems accounted for approximately ⅗th of the $500B Department of Defense budget in 2006 (Gorsich, 2007). To ensure readiness and decrease these costs for ground vehicle fleets, health monitoring technologies are being developed to assess the reliability of individual vehicles within each fleet.

Based on a review of the open literature including Technical Note 85-3 (Thomas, 1985) on ground equipment reliability issues associated with materials, it can be concluded that the most common faults occur in wheel ends (tires, brakes), suspensions, and frames. For example, Aardema (1988) discussed a ball joint failure in the HMMWV (High Mobility Multi-purpose Wheeled Vehicle). Braking systems have also experienced wear most likely due to severe operating conditions such as overheating. Reliability issues in suspensions due to wheel weights have also been reported (FORSCOM, 2004). Faults in the HMMWV body chassis and frame have also been reported in reliability centered maintenance studies (Lasure, 2004).

The response of the HMMWV to a cleat excitation has been studied by Faller, Hillegass, and Docimo (2003). The response of the center of mass, driver, and left and right wheel of the HMMWV was experimentally determined with accelerometers during a road test over a 4 inch high semicircle cleat. The road test was conducted at vehicle speeds of 5 and 14 mph. The speed was found to affect the response of the vehicle.

Many health monitoring systems usually place all measurement instrumentation on the vehicle itself to measure vehicle responses. However, Champoux, Richard, and Drouet (2007) have used an instrumented bump to study the wheel response of a bicycle. The bump was instrumented with biaxial force transducers. The rest of the bicycle was instrumented with strain gages and accelerometers to measure the cyclist's comfort.

Dynamics-based health monitoring can be used to identify faults because vibrations are a passive source of response data, which are global functions of the loading and mechanical properties of the vehicle. One way of detecting faults in mechanical equipment, such as the suspension and chassis of a ground vehicle, is to compare measured vibrations to a reference (or healthy) signature to detect anomalies. In order to make this comparison, a library of vibration signatures must be developed and categorized according to the operational conditions of the vehicle (speed, terrain, turning radius, etc.). FIG. 1 illustrates this common approach to fault identification.

There are two principle difficulties with this approach. First, the number of datasets required to develop a library of possible healthy signatures extracted from an N-dimensional sensor suite on a vehicle given M terrains on which that vehicle can operate is of order MN (Bishop, 1990). For example, 6 sensors over 10 terrains would require that one million datasets be used to establish a fully populated reference set for fault detection. If 240 datasets are acquired each day on average, then it would take 11 years to develop this library of healthy signatures for each individual ground vehicle. This large number of datasets would be needed to characterize the normal operational response of the vehicle due to the non-stationary nature of the loading and the inability to control these loads in operation. Second, many vehicles are not equipped with sensors nor the acquisition systems to acquire, process, and store data; therefore, to implement health monitoring for condition-based maintenance, one needs to overcome the economic and technical barriers associated with equipping ground vehicles to continuously monitor their responses.

What is needed is a system that can be more user friendly, simplified, more reliable, and/or require less data. Various embodiments of the present invention provide some or all of the aforementioned aspects.

### SUMMARY OF THE INVENTION

One aspect of some embodiments of the present invention pertains to a portable instrumented device that is part of a roadway. As a vehicle drives over the device, the response of the device to the vehicle is measured.

Another aspect of some embodiments pertains to a method of diagnosing the condition of a mechanical system. An instrumented, resilient device is placed between some portion of the system and the system's environment. The sensor can measure various loads, disturbances, forces, and the like that are imparted by the system onto the environment.

Yet another aspect of other embodiments of the present invention pertains to the placement of a device on a roadway, and driving a vehicle over the device. The device elastically deforms in shape as the vehicle traverses over it. One inventive method further includes sensing the deformations, and relating the deformations to motion of the device or the force exerted on the device on the vehicle.

Yet another aspect of other embodiments of the present invention pertain to various methods for comparing the response of an instrumented roadway on a first, later occasion to the response of the same vehicle on instrumented roadway at an earlier occasion. The responses preferable include data responding to movement of the roadway (such as with a resilient section of roadway) in terms of the time domain or frequency domain.

in yet another aspect, a diagnostic cleat has been developed for measuring the dynamic forces exerted on the wheels of a ground vehicle as the vehicle traverses the cleat. By comparing the responses obtained from the various wheels with one another and with baseline data corresponding to “healthy” wheels, faults in the wheel end and suspension can be detected. Further, the responses can be used to diagnose other problems in the vehicle, such as a cracked or bent subframe, defective motor mount, and others. The diagnostic cleat can also be utilized for (a) estimating reduced-order dynamic models of the vehicle and (b) estimating terrains traversed by the vehicle if on-board sensors 27 are used to complement the off-board sensors 60 in the cleat.

One embodiment of the present invention pertains to a multi-stage model estimation, terrain estimation, and damage estimation approach as it applies to a simplified model of a ground vehicle. The approach uses an over-determined set of input-output equations to minimize the error across the set of equations that define the vehicle model. This model relates the base excitation spectrum supplied by the cleat 50 for a given vehicle speed to the response spectra that are acquired on the vehicle (sprung and unsprung masses) as it traverses the cleat while the vehicle exits and enters a motor pool. This model can also be stored on-board the vehicle as it traverses various terrains over the course of the mission.

As the vehicle conducts its mission, the model is used together with the measured vehicle responses to estimate the terrain base excitation spectrum to the wheel 24. This estimate of the base excitation can then be used for at least two purposes in some embodiments. First, it can be used as a means of estimating the usage of the vehicle through rainflow fatigue analysis. Second, the estimate of the base excitation can be used together with the vehicle model to update the model thereby providing an indication of the degradation that is experienced by the vehicle over the course of the mission.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is excessive and unnecessary.

### BRIEF DESCRIPTION OF THE DRAWINGS

FIG. 1 is an illustration of one approach for diagnosing faults in ground vehicles using dynamic response and operational data.

FIG. 2 is an illustration of a concept according to one embodiment of the present invention for an instrumented cleat that diagnoses vehicle faults according to one embodiment of the present invention.

FIG. 3 is a photographic representation of a vehicle for which a model has been developed according to one embodiment of the present invention.

FIG. 4 shows a simplified four degree of freedom model for a vehicle according one embodiment of the present invention.

FIG. 5 is a graphical representation of t₁ and t₂ cleat inputs acting on front and rear tires.

FIG. 6 is a graphical representation of X₁(f) and X₂(f) cleat inputs acting on front and rear tires.

FIG. 7a is a graphical representation of Bode diagrams (magnitude and phase) for the following output/input frequency response functions: F₁/X₁, and F₂/X₁.

FIG. 7b is a graphical representation of Bode diagrams (magnitude and phase) for the following output/input frequency response functions: F₁/X₂, and F₂/X₂.

FIG. 8 is a graphical representation of Bode diagram according to one embodiment of the present invention for input at front wheel and output force in front tire for an undamaged case (solid line), damage in front suspension (long dashes), and damage in front wheel (short dashes) showing frequency ranges sensitive to damage.

FIG. 9 is a graphical representation of forced response in the (a) time and (b) frequency domains with and without a fault introduced in the front suspension using the complete (short dashes) and partial force time histories.

FIG. 10 is a graphical representation of the magnitude of change in force for a suspension and tire fault using the complete (short dashes) and partial force time histories.

FIG. 11 is a graphical representation of percentage change in magnitude of change in force for a front tire fault for a 12 in, 24 in and 32 in wide cleat using the complete force time histories.

FIG. 12a is a photographic representation of an instrumented cleat according to one embodiment of the present invention.

FIG. 12b is a photographic representation of a tri-axial accelerometer installed in the apparatus of 12a.

FIG. 13 is a photographic representation of a metal space inserted into the coil to simulate suspension fault.

FIG. 14 is a graphical representation of acceleration responses on (a) right and (b) left sides of the apparatus of FIG. 12a with (solid line) vertical, lateral (long dashes), and tracking (short dashes) directional responses with 35 psi tire pressure and 5 mph.

FIG. 15 is a graphical representation of front vertical acceleration responses on (a) right and (b) left sides of instrumented cleat with first baseline, (short dashes) second baseline, and faulty datasets indicating fault near 7.5 and 15 Hz.

FIG. 16 is a graphical representation of the comparison of a fault index according to one embodiment of the present invention for second baseline dataset (higher line) and faulty dataset (lower line) indicating larger differences due to the fault than due to measurement variability.

FIG. 17 is a graphical representation of rear vertical acceleration responses on (a right and 9b) left sides of instrumented cleat with first baseline, (short dashes) second baseline, and faulty datasets indicating no fault.

FIG. 18a is a photographic representation of an instrumented cleat according to another embodiment of the present invention.

FIG. 18b is a view looking downward on a pictorial representation of a test configuration according to one embodiment of the present invention shows a test configuration.

FIG. 19 is a graphical representation of time histories spectra for the apparatus of FIG. 18a as used in the test configuration of FIG. 18b for initial baseline (East bound) with three channels of acceleration data in the X, Y, and Z directions on both sides of the instrumented cleat (vehicle moving East bound, right side: X, Y, and Z; and left side: X, Y, and Z).

FIG. 20 is a graphical representation of X, Y, and Z accelerations for accelerometer #2 for East bound traveling vehicle over the apparatus of FIG. 18a (front wheels).

FIG. 21 is a graphical representation of X, Y, and Z accelerations for accelerometer #1 for East bound traveling vehicle over the apparatus of FIG. 18a (front wheels).

FIG. 22 is a graphical representation of frequency spectra for initial baseline (East bound) with three channels of acceleration data in the X, Y, and Z directions on both sides of the instrumented apparatus of FIG. 18a (Looking East bound, right side: X, Y, and Z; and left side: X, Y, and Z.

FIG. 23 is a graphical representation of frequency spectra for (a) initial baseline, (b) final baseline, (c) right-front suspension fault, and (d) right-front tire pressure fault with three channels of acceleration data in the X, Y, and Z directions on both sides of the instrumented apparatus of FIG. 18a (right side: X, Y, and Z; and left side: X, Y, and Z.

FIG. 24 is a graphical representation of the relationship between (a) frequency response functions and (b) left and right wheel forces for initial baseline (East bound) with three channels of data in X, Y, and Z.

FIG. 25: is a graphical representation of the maximum normalized feature for thirty datasets for accelerometers (a) #1 and (b) #2 for 700-900 Hz frequency range for X, Y, and Z directions for comparison datasets.

FIG. 26 is a simplified quarter-car model according to one embodiment of the present invention showing base excitation and two on-board vehicle response measurements on sprung and unsprung masses.

FIG. 27 shows a process according to another embodiment of the present invention for model estimation and terrain estimation using a combination of off-board diagnostic cleat and on-board measurements.

FIG. 28 shows the process according to another embodiment of the present invention for model updating and damage estimation based on the estimated terrain input.

FIG. 29a is a graphical representation of a cross section of a cleat on a roadway according to one embodiment of the present invention.

FIG. 29b is a graphical representation of a cross section of a cleat on a roadway according to another embodiment of the present invention.

FIG. 29c is a graphical representation of a cross section of a cleat on a roadway according to another embodiment of the present invention.

FIG. 29d is a graphical representation of a cross section of a cleat on a roadway according to another embodiment of the present invention.

FIG. 29e is a graphical representation of a cross section of a cleat on a roadway according to another embodiment of the present invention.

FIG. 30a is a view from above of a pictorial representation of a roadway with a plurality of cleats according to another embodiment of the present invention.

FIG. 30b is a view from above of a pictorial representation of a roadway with a plurality of cleats according to another embodiment of the present invention.

FIG. 30c is a view from above of a pictorial representation of a roadway with a plurality of cleats according to another embodiment of the present invention.

FIG. 30d is a view from above of a pictorial representation of a roadway with a plurality of cleats according to another embodiment of the present invention.

FIG. 31a is a top view of a cleat on a roadway according to another embodiment of the present invention.

FIG. 31b is a top view of a cleat on a roadway according to another embodiment of the present invention

FIG. 31c is a top view of a cleat on a roadway according to another embodiment of the present invention.

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that must be included in all embodiments, unless otherwise stated.

The use of an N-series prefix for an element number (NXX.XX) refers to an element that is the same as the non-prefixed element (XX.XX), except as shown and described thereafter. As an example, an element 1020.1 would be the same as element 20.1, except for those different features of element 1020.1 shown and described. Further, common elements and common features of related elements are drawn in the same manner in different figures, and/or use the same symbology in different figures. As such, it is not necessary to describe the features of 1020.1 and 20.1 that are the same, since these common features are apparent to a person of ordinary skill in the related field of technology. Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only. Further, with discussion pertaining to a specific composition of matter, that description is by example only, does not limit the applicability of other species of that composition, nor does it limit the applicability of other compositions unrelated to the cited composition.

It is understood that various embodiments of the present invention can utilize many different configurations of cleats. Some, but not all, of these different cleat configurations are described with relation to an integer number (XX) in front of the number 50 (XX50), and also some, but not all, are referred to with prime (′) and double prime (″) suffixes. It is understood that in many cases cleats with various prefixes and suffixes can be substituted in different embodiments for cleats having different prefixes or suffixes. Further, it is understood that reference to “cleat 50” in this specification includes reference to all cleats described herein as would be understood by a person of ordinary skill in the art.

It is further understood that reference to a “wheel” is a reference to the rotating device that supports the vehicle from the roadway, terrain, runway, factory floor, or other vehicle path. For example, in an automobile it is understood that reference to a “wheel” can be construed as reference to the tire, especially in those situations in which there is reference to driving the wheel over a cleat. However, various embodiments of the present invention are not so limited, and include those vehicles having metallic wheels in contact with a roadway (including trains in which the “roadway” is a train track), industrial vehicles such as Bobcats® (in which substantially solid rubber tires are mounted on metallic wheels, and in which the roadway is an aisle within a factory), and airplanes (in which a pneumatic tire is in contact with a roadway that is a runway). Further, it is understood that reference to a “roadway” is reference to any surface over which the vehicle is being driven.

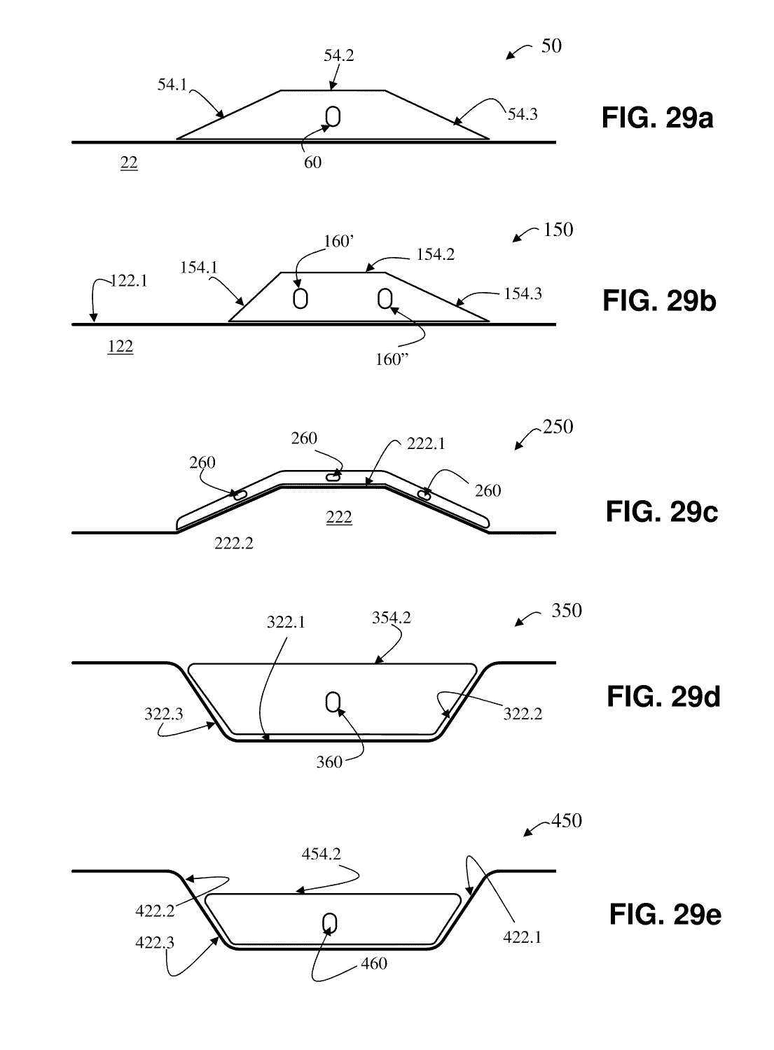

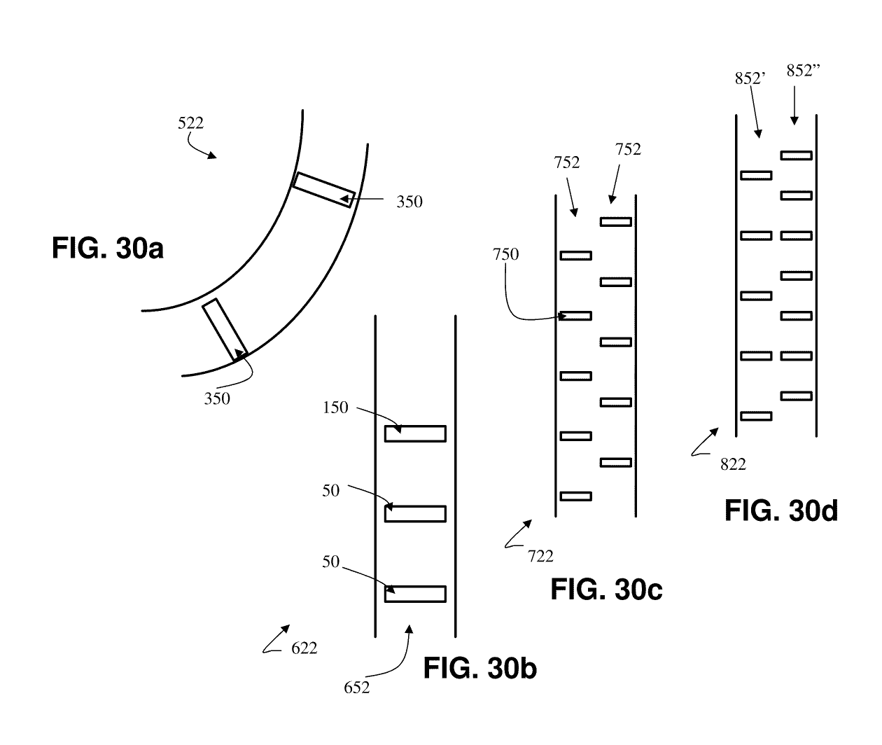

Although reference is made herein to instrumented cleats that are portable, it is understood that portability is not a requirement. In some embodiments of the present invention, the instrumented cleat is a resilient change in elevation of the roadway, either a bump or trough, that is substantially built into the roadway, and which is generally non-portable. The term “resilient” is a generalized reference to Hooke's law, such that the material and/or mechanical configuration is chosen such that there is a measurable displacement within the frequency ranges of interest to the traversing of a vehicle over the cleat. For example, in some embodiments a cleat can be fabricated from an elastomeric material that is molded in place onto a roadway, especially a molded cleat positioned within a channel cut into the surface of the roadway. As other examples, any of the cleats shown in FIGS. 29 and 30 are non-portable in some embodiments of the present invention. In some embodiments, a cleat is any localized elevational change in the vehicle path. In other embodiments, the cleat is substantially portable having dimensions of less than about five feet in length, less than about two feet in width (in the direction of driving), and less than about one foot in height.

Reference is made herein to means for measuring a response of a roadway to a vehicle, which because of Newton's relationships pertaining to action and reaction, is the same a means for measuring the response of the vehicle to the roadway. Such means for measuring response pertains to any of the cleats shown and described herein, along with any of the movement sensors shown and described herein. As but two examples, means for measuring response include a cleat 50 including a single axis accelerometer, and further include a cleat 350 including triaxial displacement or strain measurements. Further, means for changing the elevation of a vehicle refer to any of the cleats shown and described herein, as well as their equivalents. As but one example, means for changing the elevation of a vehicle include a plurality of cleats 250 arranged in patterns 852′ and 852″. In addition, as used herein, means for sensing include any of the movement sensors described herein, and further any sensors that can detect motion of or force upon a resilient elevational change of a roadway, and their equivalents. As nonlimiting examples, means for sensing includes accelerometers, velocity sensors, position sensors, strain gages, force transducers, and the like, whether operating electromechanically, electro-optically, or in any manner.

It is useful to consider how rotating machinery diagnostic systems function. In these machines, the repetitiveness of the operating load for a machine operating at constant speed makes it relatively easy to identify faults in the bearings, shaft, etc. In wheeled ground vehicles, loading varies significantly as mentioned above. If loads acting on the vehicle could be fully measured or controlled in terms of the terrain input motions and/or spindle forces/moments, fault identification in wheeled vehicles at the component level would be more straightforward. Mechanical properties that determine the vehicle condition could be extracted from data if loads could be controlled. There are at least two approaches to overcome some of the difficulties mentioned above:

(1) If a vehicle cannot be equipped with sensors, then an instrumented diagnostic cleat 50 is proposed in some embodiments as illustrated in FIG. 2 to measure the dynamic response of the vehicle 20.1 as it traverses the cleat at a speed. This approach could be effective because it does not need on-vehicle sensors. FIG. 2 illustrates an assembly line of new built vehicles or rebuilt vehicles, with a specific vehicle 20.1 about to undergo tests by being driven over cleat 50. Vehicles 20.2 are members of the same family as vehicle 20.1. Data taken from the three vehicles of FIG. 2 can be used to establish baseline (or family) datasets. Further, FIG. 2 can be viewed as a plurality of vehicles that have not yet been analyzed, but will be analyzed and then repaired.

In one aspect of the present invention, the general configuration of cleat 50, both with regards to geometry and placement and type of sensors, is substantially the same as a cleat that was used for a previous test. For example, as shown in FIG. 2, vehicle 20.1 may be undergoing its first test, which will then establish its infant responses, if for a new vehicle. These responses can be stored onboard, and then compared later to responses from the same vehicle when driven over a different cleat 50 placed on a different roadway.

(2) If a vehicle can be equipped with sensors, then a “reference-free” approach to data analysis is used to compare similar response pathways on the vehicle to identify mechanical anomalies. For example, the vertical and tracking responses of the left wheels can be compared to the same responses of the right wheels to determine if the front/rear wheels exhibit anomalies. This approach could be effective because it diminishes the need for reference signatures to identify faults.

Some of the first aspects of the first approach includes: the cleat 50 is portable making it practical for field use; cleat can be engineered to control the amplitude and frequency of the input imparted to the vehicle wheels allowing for more targeted diagnostic results; vehicle speed traversing the cleat can be controlled; the configuration of cleats can be designed to develop specific tests for certain subsystems; sensors are installed within the cleat (or proximate to the cleat such that the sensors provide a response related to movement of the cleat) rather than the vehicle providing greater reliability; and algorithms for analyzing response data from the cleat can be less complex than for on-vehicle diagnostic algorithms, which must address non-stationary data.

An instrumented diagnostic cleat according to one embodiment of the present invention can overcome the economic and technical barriers associated with onboard health monitoring systems. The diagnostic cleat measures the dynamic response of the vehicle as it traverses the cleat at a speed. Then the dynamic response is compared to a baseline reference (or healthy) response to detect anomalies, which correspond to faults within the vehicle. The diagnostic cleat addresses some of the various aspects associated with variations in the terrain assuming a fixed vehicle speed and cleat profile. The cleat can also eliminate the need for onboard vehicle equipment, and in some embodiments it is portable so one cleat can diagnose a fleet of vehicles.

Various embodiments of the present invention contemplate driving a vehicle over an instrumented change in elevation, and measuring the response of the change in elevation. Preferably, the vehicle is driven over the elevational change at a particular predetermined velocity within a range of velocities. The range of velocities can be selected to correspond to the baseline dataset to which the potentially faulted vehicle responses will be compared. As one example, and of situations in the baseline data is from a family of substantially similar vehicles, the range of velocities may be relatively substantial, and contemplation that at the time of testing the driver of the specific vehicle is in a future, unknown situation. In such cases, the baseline or family data may be taken over a fairly wide range of velocities (perhaps five mph to twenty mph), with baseline response data recorded and processed as a function of the velocity of the baseline vehicle (for example, baseline data can be taken in one mph increments over the range). However, in yet other embodiments, the baseline data may have been taken relatively recently, in which case it may be preferable to have a rather narrow predetermined range (as one example, +/−1 mph of range about a particular target velocity). Various embodiments of the present invention contemplate providing feedback to the driver if he is outside the predetermined range, such that the driver performs a second attempt at creating a dataset.

In yet other embodiments, dataset can be taken at any velocity, and the dataset can be subsequently normalized or adjusted for velocity effects. As one example, it may be possible to adjust a dataset (either a baseline dataset or a specific dataset) in a linear, inverse, or squared relationship relative to velocity. The later may be useful in those situations where the response of the cleat sensors corresponds most directly to the kinetic energy of the vehicle. Further, such normalizations and adjustments can be of one type at frequencies proximate to a known resonant frequency of the vehicle system, and of a different type at frequencies inbetween known resonant frequencies. As non-limiting examples, a time-domain peak-G response of a specific dataset may be adjusted in amplitude by the inverse of vehicle velocity. As a further non-limiting example, a frequency-domain response of magnitude proximate to a known resonant frequency may be adjusted by the inverse of the square of vehicle velocity.

FIGS. 29a, 29b, 29c, 29d, and 29e are cross sectional representations of elevational changes and cleats according to various embodiments of the present invention. FIG. 29a is a cross section of a cleat 50 located on the top surface of a roadway 22. Cleat 50 has a cross section that is symmetrical about a vertical axis. The cross sectional shape is generally that of a truncated pyramid, with an entrance portion 54.1 leading to a transition portion 54.2, and ending with an exit portion 54.3. A sensor 60 is located generally within the body of cleat 50.

The underside of cleat 50 is flat, and generally adapted to conform to the surface of the roadway. However, the underside of the cleat can also be configured to couple to the roadway (such as for a roadway including an outwardly projecting coupling feature or a downwardly projecting coupling feature. One example of the former would be a T-shaped bar extending across the roadway and anchored to the roadway. In such a case the underside of the cleat can have the complimentary T-shape, such that the cleat would slide over the bar. Further, the roadway can include a downwardly projecting coupling feature such as a rectangular channel. In such an embodiment the underside of the cleat would have a corresponding rectangular projection that would fit within the channel. Such configurations of the cleat may be useful in those applications in which the cleat is considered not only portable, but also fixed other than by friction to the roadway.

FIG. 29b depicts a cross section of a cleat 150 according to another embodiment of the present invention. Cleat 150 is located on a largely flat surface 122.1 of a roadway 122. Cleat 150 is not symmetric about any vertical axis. Cleat 150 includes an entrance section 154.1 that is more steeply inclined than the exit section 154.3. Further, the present invention contemplates those embodiments in which the entrance section is less steeply inclined than the exit section. Further, cleat 150 includes a pair of sensors 160 located at different horizontal stations along the fore and aft direction in which the vehicle is driven. Further, the present invention contemplates those embodiments in which the cleat includes multiple sensors that are of different types. As on example, sensor 160′ can be an accelerometer of one or several axes. The second sensor 160″ can be a strain gage, temperature sensor, magnetic pick-up, or any other type that will respond to the presence of the vehicle under test.

FIG. 29c depicts a cleat 250 of largely constant thickness that is located on top of a bump in roadway 222. In some embodiments, this bump is fabricated with a predetermined elevational change 222.2, including entrance, transitional, and exit portions similar to that previously described. In the embodiment shown in FIG. 29c, the cleat 250 is configured as a resilient, thin, constant thickness mat that generally conforms to the surface elevational changes 222.2. In some embodiments, cleat 250 includes sensors 260 on each of the entrance, transition, and exit portions of the mat.

FIG. 29d is a graphical representation of a resilient cleat 350 that is adapted and configured to provide relatively little or no elevational change to the tire of the vehicle. Cleat 350 includes a transitioned section 354.2 that is at substantially the same height as the surface of roadway 322 before and after cleat 350. In embodiments such as that depicted in FIG. 29d, the tire of the vehicle changes elevation when traversing cleat 350 based mainly on the compressive characteristics of the cleat material, and further in regards to the manner in which the cleat fills the trough 322.3 in roadway 322. As examples, a cleat 350 constructed of a relatively stiff resilient material, and further shaped to fill the entire cross sectional shape of trough 322.3 would compress relatively little when supporting the forces from the tire. In contrast, a relatively soft elastomeric material formed into a shape that leads voids or other volumes in which compressed rubber can flow would compress a larger amount when supporting the same tire forces.

FIG. 29e depicts a cleat 450 within a tough 422.3. As compared to FIG. 29d, it can be seen that cleat 450 is adapted and configured to have a top transitional portion 454.2 that is at a height lower than the height of the roadway surface 422.1 leading toward cleat 450 or away from cleat 450. Further, it is understood that yet other embodiments of the present invention contemplate a cleat resting within a trough (as shown in FIGS. 29d and 29e), but with a top transitional surface that is at an elevation above the surface of the roadway. In such an embodiment a vertical bump is induced into the tested vehicle (as in FIGS. 29a, 29b, and 29c), but in a configuration allowing a cleat fabricated from a substantially thicker cross sectional shape.

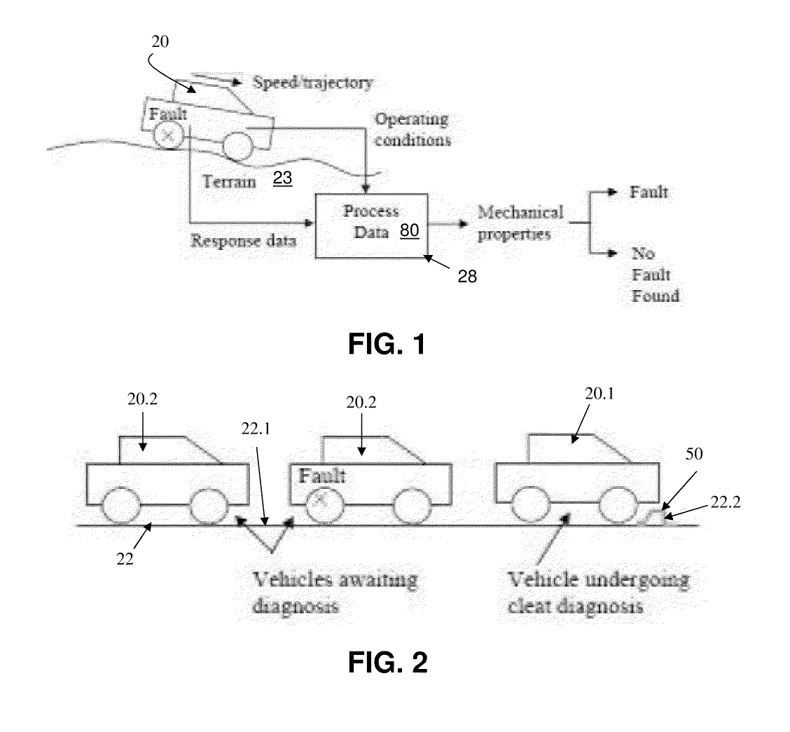

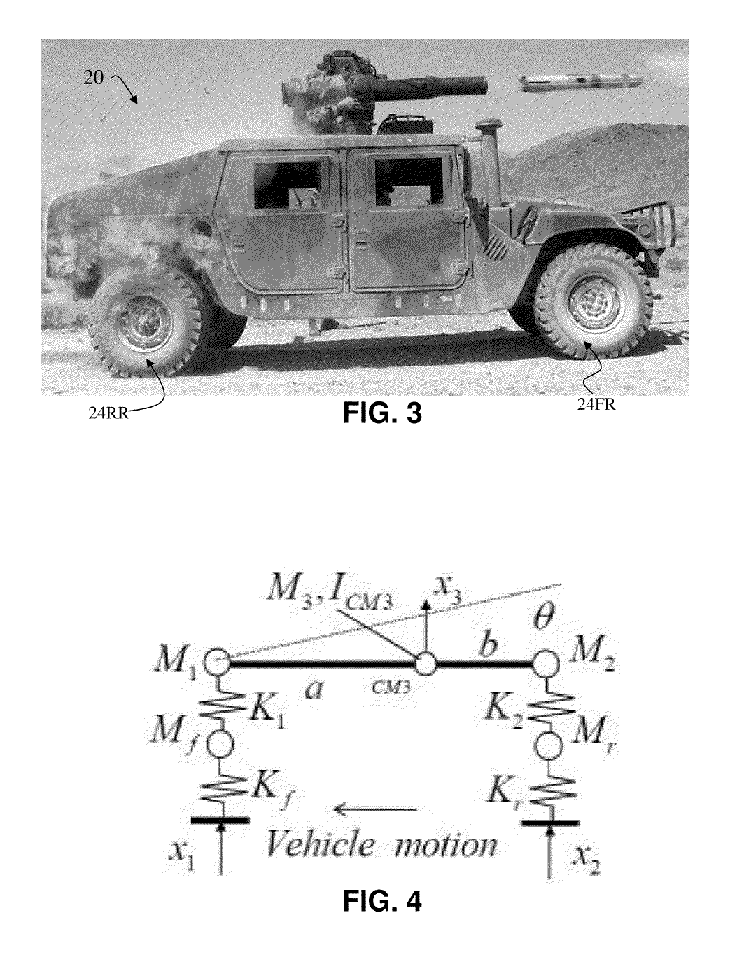

Dimensional and material data was obtained in the open literature regarding American General's standard HMMWV. FIG. 1 shows a photo of the vehicle, which has been represented using a four degree of freedom lumped parameter model as shown in FIG. 4. It has a length of 4.6 m, width of 2.1 m, height of 1.8 m, and mass of 2340 kg. The frame is modeled as a rigid body with three lumped masses, Mj with j=1, 2, and 3, representing the front, rear, and center of mass payloads carried by the vehicle. The mass moment of inertia about the center of mass is Icm3. Dimensions a and b describe the location of the center of mass. The tire stiffness properties are denoted by K_{f} and Kᵣ for the front and rear wheels, respectively. K₁ and K₂ denote the front and rear suspension rate properties, respectively. Although not indicated in the schematic, proportional viscous damping is assumed in the model.

The vertical base motions of the front and rear tires are denoted by x1 and x2. The vertical and pitch motions of M3 and Icm3 are denoted by x3 and q, respectively. The nominal parameter values that were used in the model are listed in Table 1.

TABLE 1
Nominal parameter values in four degree of
freedom modelof HMMWV

| Parameter | Value | |
|---|---|---|
| M₁, M₂, M₃ | 950, 80, 1000 | kg |
| M_{f}, _{Mr} | 100,100 | kg |
| I_{cm3} | 10 | kg m² |
| a, b | \|10, 5 | ft |
| K₁, K₂ | 50000, 40000 | N/m |
| K_{f}, Kᵣ | 500000, 400000 | N/m |

The lumped parameter set of differential equations corresponding to this model was derived using Newton-Euler methods and is given below:

$$[ \begin{matrix}{M}_{1} + {M}_{2} + {M}_{3} & 0 & 0 & 0 \\ 0 & {I}_{cm 3} & 0 & 0 \\ 0 & 0 & {M}_{f} & 0 \\ 0 & 0 & 0 & {M}_{r}\end{matrix} ] \{ \begin{matrix}{\ddot{x}}_{3} \\ \ddot{θ} \\ {\ddot{x}}_{f} \\ {\ddot{x}}_{r}\end{matrix} \} + [ \begin{matrix}{K}_{1} + {K}_{2} & * & * & * \\ - {K}_{1} ( a + c ) + {K}_{2} ( b - c ) & - {K}_{1} ( a + c ) + {K}_{2} ( b - c ) & * & * \\ - {K}_{1} & {K}_{1} ( a + c ) & {K}_{f} + {K}_{1} & * \\ - {K}_{2} & - {K}_{2} ( b - c ) & 0 & {K}_{r} + {K}_{2}\end{matrix} ] \{ \begin{matrix}{x}_{3} \\ θ \\ {x}_{f} \\ {x}_{r}\end{matrix} \} = \{ \begin{matrix}0 \\ 0 \\ {K}_{f} {x}_{1} \\ {K}_{r} {x}_{2}\end{matrix} \} \qquad ( 1 )$$

where c=(b·M₂−a·M₁)/(M₁+M₂+M₃) and an “*” in the stiffness matrix indicates a symmetric entry in the matrix with respect to the diagonal. A viscous proportional damping model of the form,

[C]=α[M]+β[K], α=0, β=0.02 (2)

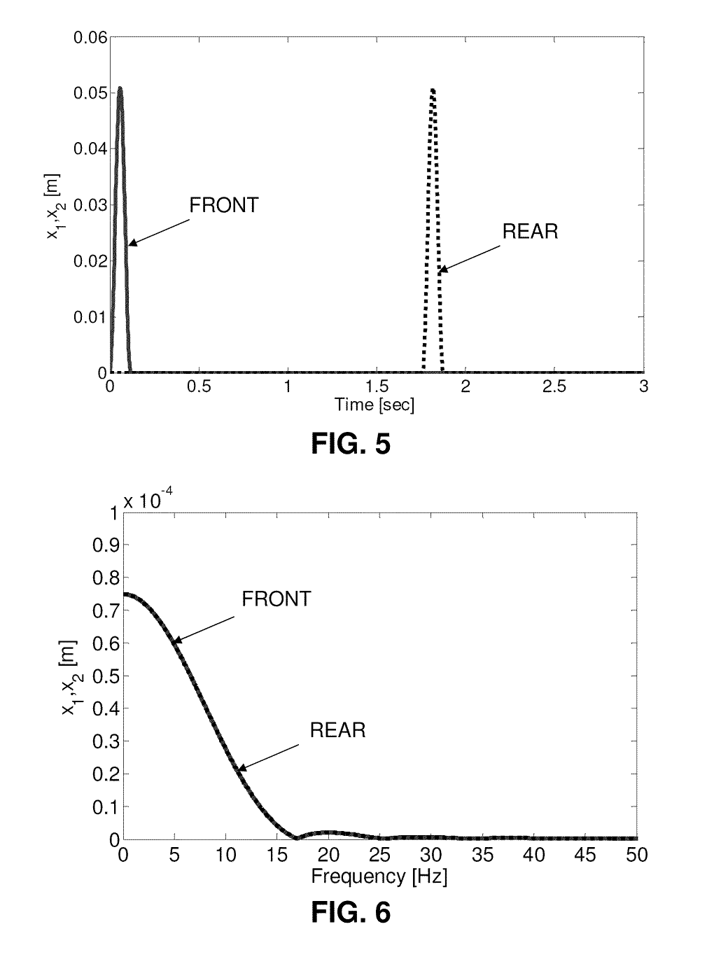

is also used in Eq. (1) to describe the dissipative (nonconservative) effects. The functions x₁ and x₂ were used to model the profile of the cleat, which provides a base excitation to each wheel at different times. x₁ and x₂ were expressed using a Hanning function of the form:

$${x}_{1} ( t ) = \{ \begin{matrix}\frac{h}{2} ( 1 - cos \frac{2 π t}{{T}_{c}} ) & for t \leq {T}_{c} \\ 0 & for t > {T}_{c}\end{matrix} \\ {x}_{2} ( t ) = {x}_{1} ( t - {T}_{b} ) \qquad ( 3 )$$

where h is the height of the cleat, T_{c} is the time during which a wheel is in contact with the cleat, and T_{b} is the time it takes for the rear wheel to come into contact with the cleat after the front wheel has reached the cleat. T_{c} can be calculated using the length of the cleat L and the speed of the vehicle v, T_{c}=L/v. Likewise, T_{b} can be calculated using the distance from wheel to wheel (wheelbase) w and the speed, T_{b}=w/v. x₁ and x₂ are plotted in FIG. 5 for a 15 ft wheelbase, 12 in wide cleat, and speed of 5.8 mph. Part of the instrumented cleat design is associated with the frequency range over which these cleats excite the vehicle. Therefore, the frequency spectra of these base excitation time histories are also plotted in FIG. 6. Both inputs produce the same spectral features because they are identical in amplitude but different in phase. The bandwidth of these excitations is 94 rad/s.

The input-output model in Eq. (1) was then rewritten in state variable form in preparation for conducting time domain simulations. The state vector in this state space representation of the model consisted of the response vector from Eq. (1) and its derivative. The state variable model is given by,

$$\frac{d}{d t} \{ \begin{matrix}\{ x \} \\ \{ \dot{x} \}\end{matrix} \} = [ \begin{matrix}{[ 0 ]}_{4 \times 4} & {[ I ]}_{4 \times 4} \\ - {[ M ]}^{- 1} [ K ] & - {[ M ]}^{- 1} [ C ]\end{matrix} ] \{ \begin{matrix}\{ x \} \\ \{ \dot{x} \}\end{matrix} \} + [ \begin{matrix}{[ 0 ]}_{6 \times 2} & {[ 0 ]}_{6 \times 2} \\ {[ \begin{matrix}{M}_{f} & 0 \\ 0 & {M}_{r}\end{matrix} ]}^{- 1} [ \begin{matrix}{K}_{f} & 0 \\ 0 & {K}_{r}\end{matrix} ] & {[ \begin{matrix}{M}_{f} & 0 \\ 0 & {M}_{r}\end{matrix} ]}^{- 1} [ \begin{matrix}β {K}_{f} & 0 \\ 0 & β {K}_{r}\end{matrix} ]\end{matrix} ] \{ \begin{matrix}{x}_{1} ( t ) \\ {x}_{2} ( t ) \\ {\dot{x}}_{1} ( t ) \\ {\dot{x}}_{2} ( t )\end{matrix} \} \qquad ( 4 )$$

The desired outputs of this model are the forces inside the front and rear tires because the goal of the instrumented cleat is to measure forces in the tire to identify faults in the tires and suspension. Therefore, the output equation used in this state variable model is given by:

$$\{ \begin{matrix}{f}_{1} \\ {f}_{2}\end{matrix} \} = [ \begin{matrix}0 & 0 & - {K}_{f} & 0 & 0 & 0 & 0 & 0 \\ 0 & 0 & 0 & - {K}_{r} & 0 & 0 & 0 & 0\end{matrix} ] \{ \begin{matrix}\{ x \} \\ \{ \dot{x} \}\end{matrix} \} + [ \begin{matrix}{K}_{f} & 0 & β {K}_{f} & 0 \\ 0 & {K}_{r} & 0 & β {K}_{r}\end{matrix} ] \{ \begin{matrix}{x}_{1} ( t ) \\ {x}_{2} ( t ) \\ {\dot{x}}_{1} ( t ) \\ {\dot{x}}_{2} ( t )\end{matrix} \} \qquad ( 5 )$$

The modal properties associated with the free response of the vehicle model were calculated by solving the corresponding eigenvalue problem using the state matrix in Eq. (4). The eigenvalue formulation takes the following form:

$$[ \begin{matrix}{[ 0 ]}_{4 \times 4} & {[ I ]}_{4 \times 4} \\ - {[ M ]}^{- 1} [ K ] & - {[ M ]}^{- 1} [ C ]\end{matrix} ] \{ \begin{matrix}\{ x \} \\ \{ \dot{x} \}\end{matrix} \} = λ \{ \begin{matrix}\{ x \} \\ \{ \dot{x} \}\end{matrix} \} \qquad ( 6 )$$

where {x} is the modal deflection shape and λ is the corresponding modal frequency (eigenvalue). For the mechanical properties chosen in Table 1, the eigenvalue problem in Eq. (6) was solved and the modal properties obtained are listed in Table 2. The first two modes of vibration are associated with the sprung mass (pitch and bounce) and the second two modes are associated with the wheel hop resonances of the front and rear. The modal deflection shapes are only indicated to two significant digits to highlight the dominant degrees of freedom in each mode shape. The four undamped natural frequencies are at 0.63, 0.88, 7.90, and 7.92 Hz. Consequently, when the base excitation functions shown in FIG. 6 are applied to the vehicle moving at 5.8 mph, all four modes of vibration will be excited because the bandwidth of the primary lobes in each of the input frequency spectra spans the frequency range from 0 to 15 Hz (94 rad/s). If the vehicle is traveling more slowly, it is possible that all modes of vibration will not be excited in the forces that are measured in the tires.

TABLE 2
Modal parameters of HMMWV
four degree of freedom model

| Undamped Freq. (rad/s) | Modal Vector |
|---|---|
| and Damping Ratio | (Two significant digits) |
| 4.0. 0.04 | [0.87 1.00 −0.14 −0.27]¹ |
| 5.5, 0.06 | [1.00 −0.09 0.11 0.07]¹ |
| 49.6, 0.89 | [−0.00 −0.00 −0.00 1.00]¹ |
| 49.7, 1.11 | [−0.00 0.00 1.00 0.00]¹ |

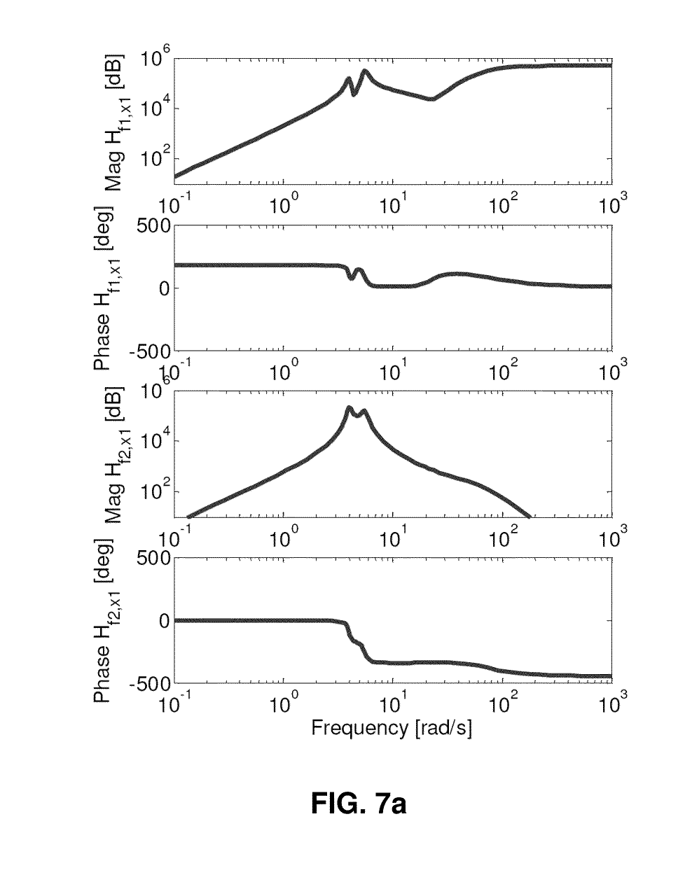

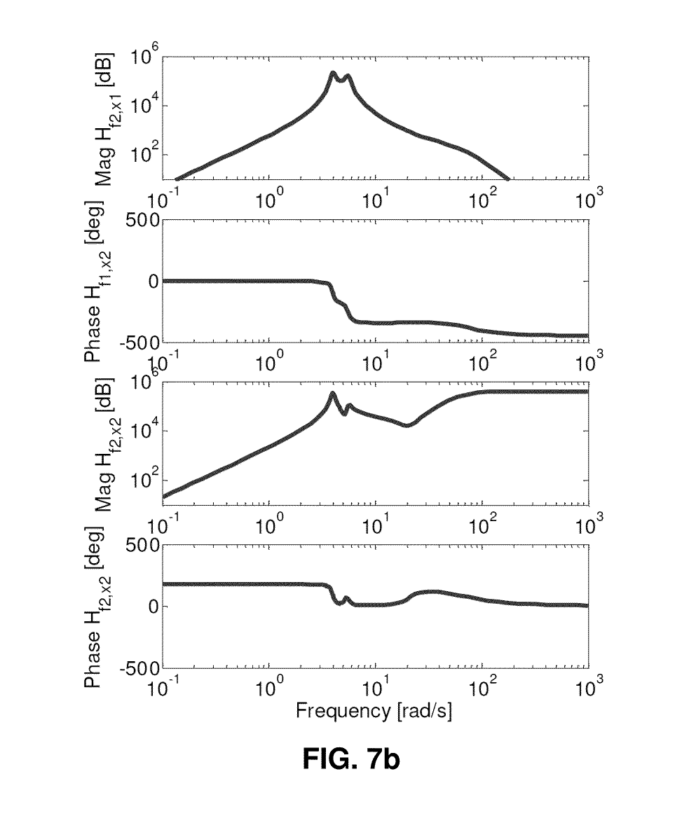

To examine the forces that are produced in the tires of the vehicle as the front and rear wheels traverse the cleat, the Bode diagrams relating the input displacements to the wheels (x₁ and x₂) and the forces in the tires (f₁ and f₂, see Eq. (5)) were constructed. The Matlab® bode function was used to produce these diagrams. These diagrams relate the amplitudes and phases of the input displacements to the amplitudes and phases of the forces measured within the instrumented cleat, which is proposed for use in diagnosing vehicle faults. FIG. 7 shows the Bode diagrams for the four frequency response functions relating the tire input displacements to the tire output forces.

The modal frequencies given above for the sprung vehicle mass are evident in the peaks of the Bode magnitude plots. The two wheel hop frequencies are also evident but are much more heavily damped than the bounce and pitch modes as expected from Table 2.

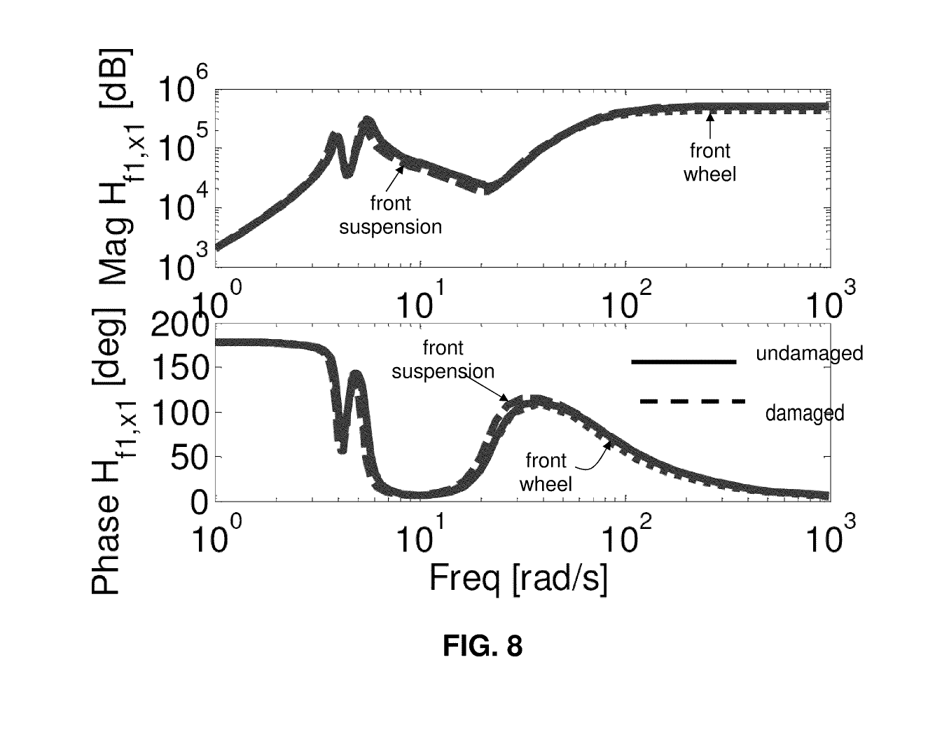

Damage due to fractured suspension tie bolts or faulty struts and tires that are underinflated or contain separated plies were analyzed. First, a 15% reduction in K₁ (see FIG. 4) is used to model damage in the front suspension. FIG. 8 shows the resulting Bode diagram relating the input displacement at the front wheel to the force in the front tire in the undamaged and damaged states. The frequency range sensitive to this damage is the mid-frequency range in the vicinity of the resonances of the sprung mass.

This result is consistent with the location of the damage in the system relative to the deflection mode shapes listed in Table 2. The bounce motion at 4 rad/s (and to a lesser extent in the pitch motion at 5 rad/s) indicate that there is more deflection and velocity across the suspension than in the tire hop deflections. Therefore, these motions of the sprung mass are sensitive to the suspension damage in K₁. In contrast, the response in the frequency range above 40 rad/s is most sensitive to changes in the front tire rate, K_{f}.

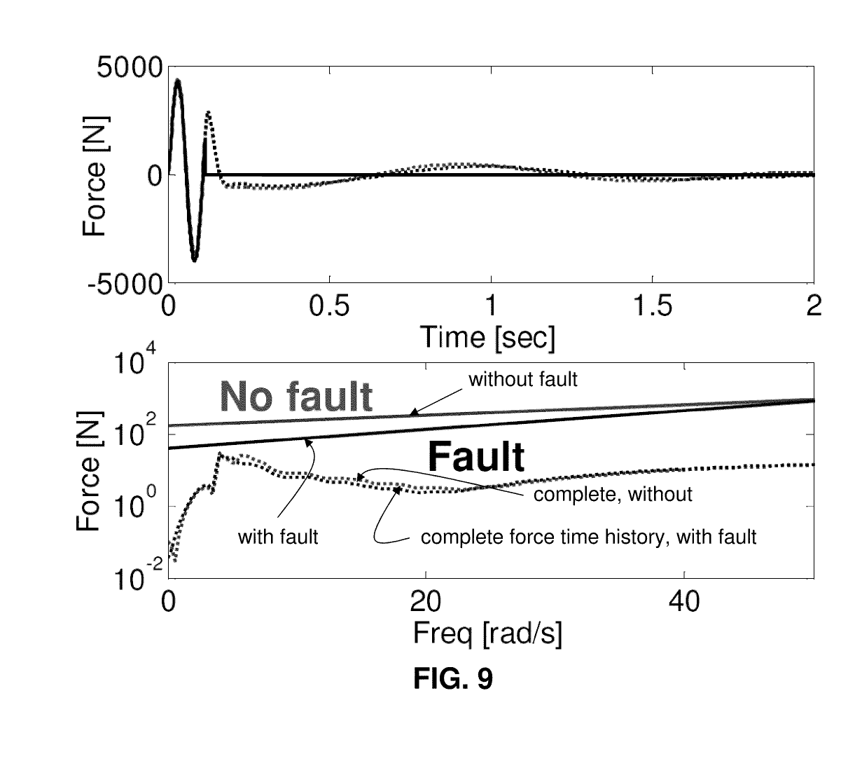

The forced response in the time and frequency domains for the excitation functions shown in FIG. 5 was then calculated. FIG. 9 shows the time and frequency domain forces in the front tires for the fault scenario involving a 15% reduction in the front suspension system. In FIG. 9(a, b), two sets of forces in the time and frequency domains in the tire are plotted. The solid lines correspond to tire forces in the undamaged and damaged vehicle assuming the force can be measured while the tire is traversing the cleat. The dotted lines correspond to the same scenario assuming the force can be measured throughout the time period shown. There are subtle changes in the time history due to a fault and more pronounced changes in the frequency spectrum. The changes in the spectrum occur in the frequency range dominated by the pitch and bounce degrees of freedom due to the sensitivity of the force in the tire to faults in the vehicle (see FIG. 8).

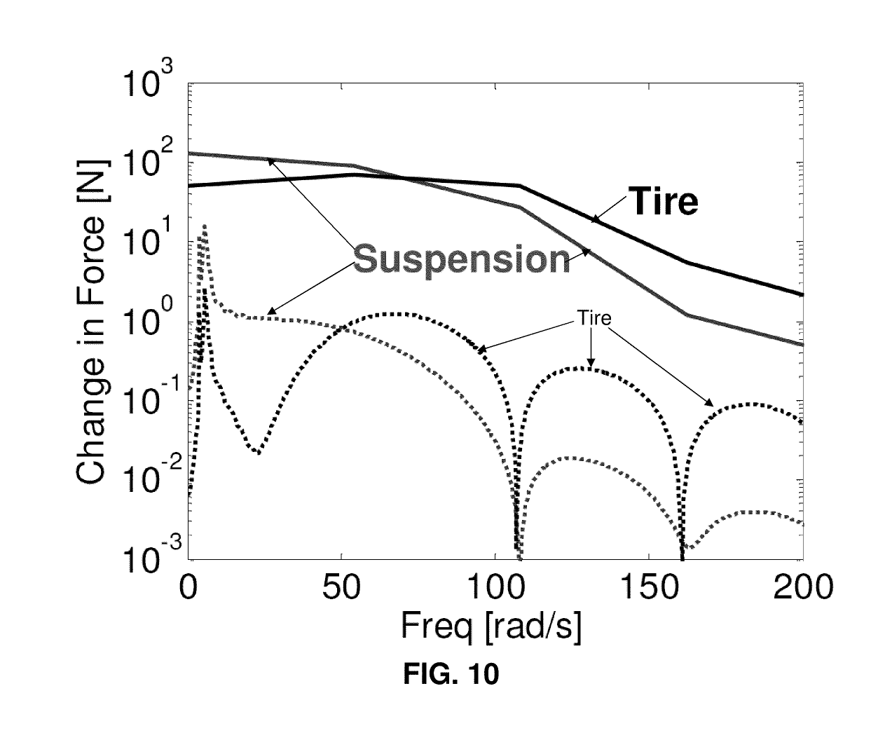

The same forced response simulation was performed for a scenario involving a 15% reduction in the front tire stiffness. Then the resulting forced response for this fault in addition to the forced response for the suspension fault were both subtracted from the undamaged forced response. The spectral magnitudes of these differences due to the two distinct faults were plotted as shown in FIG. 10 out to 200 rad/s. The effects of the suspension fault and tire fault affect different frequency ranges as explained in FIG. 8. Moreover, the suspension fault exhibits larger changes in the low frequency range whereas the tire fault exhibits larger changes in the high frequency range. When the entire force time history is measured throughout the vehicle motion, the differences due to faults are more apparent. However, the differences are also apparent in the case when only the short segment of force data is available as the tires traverse the cleat.

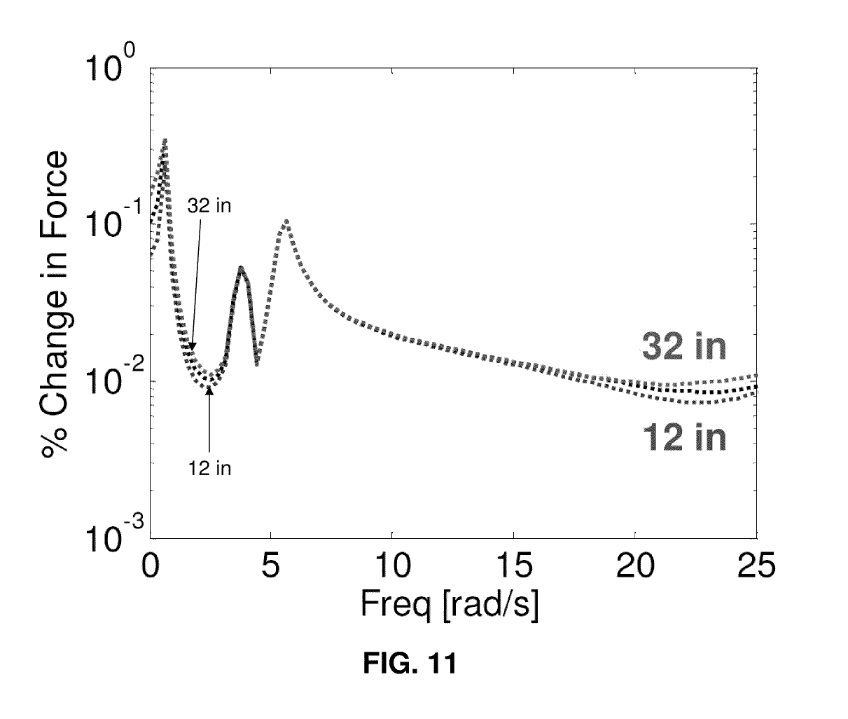

To examine the effects of a change in the aspect ratio of the cleat, the width was increased by a factor of 2 (24 in) and 3 (36 in), and the change in force was again calculated for the scenario involving only a fault in the front tire. The percentage change in force spectrum was then plotted in FIG. 11 for the case when the force is measured in the tire throughout the entire vehicle travel. The figure shows that as the width of the cleat becomes larger for a fixed height, the sensitivity to the tire fault increases throughout the entire frequency range. A wider cleat places more of the excitation in the lower frequency range resulting in larger amplitudes of displacement across the wheels and struts, which increases the sensitivity to faults in the tire. For the suspension fault, the increase in sensitivity is also noticeable for wider cleats but only in the low frequency range below rad/s. These results suggest that for a given height, changes in the width of the cleat affect the sensitivity of the measured force in the cleat to the tire faults more than to suspension faults.

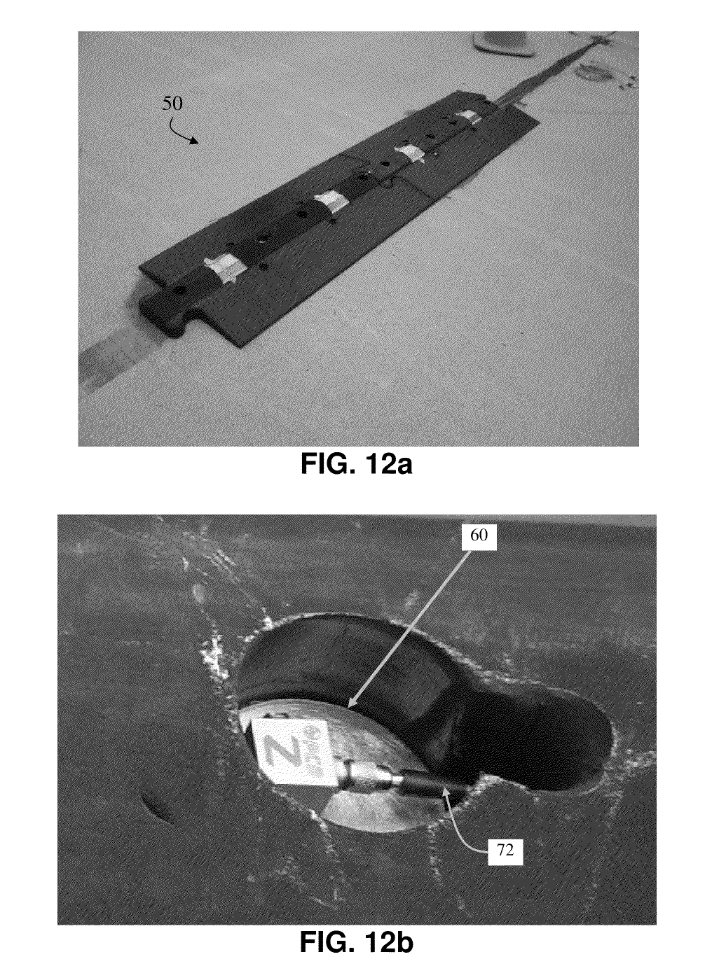

A rubberized cleat 50 was instrumented with two PCB 356A32 tri-axial accelerometers and a small truck was used as the test vehicle 20. These accelerometers were used to measure the responses on the left and right side of the cleat. These responses are indicative of the forcing function that acts through the tire as the vehicle traverses the cleat. The left and right accelerometers 60.2 and 60.1, respectively, were positioned in the center plane of the cleat using metal plugs and cables 72 were run out to the data acquisition system 70 through the base of the cleat. The plugs were installed so that they were not touching the ground to provide measurements that would be sensitive to the forces acting through the tire. The instrumented cleat 50 used in the experiment is shown in FIG. 12(a) with a close up of one of the accelerometers and plugs in FIG. 12(b).

Data is provided from the sensors 60 of cleat 50 to a data acquisition system that in one embodiment includes a computer having memory. The computer includes the electronic signal processing desirable to acquire the signal from sensor 60 and convert it to digital data. This signal conditioning can include various low pass, high pass, or bandpass filters that remove noise from the signals. The output of the signal conditioner is a digital signal representative of the time response of the sensor from the disturbance by the vehicle wheel to the cleat. The digitized time domain signal can be further analyzed in the time domain or frequency domain. Preferably the latter is performed by way of a Fourier transformation, such as by an FFT circuit card.

There are yet other sensors that provide signals to the measurement computer in various embodiments, including ambient temperature and cleat temperature. With regards to cleat temperature, in those embodiments using elastomeric cleats, the responses stored in a dataset can be adjusted for the cleat temperature, taking into account that an elastomeric cleat may be stiffer on a cold day or softer on a warm day.

Further, the software of the measurement computer tracks the time of day and location of the cleat, such as by a clock for the former and GPS information for the latter. In some embodiments, the measurement computer keeps track of the identity of the cleat (such as by serial number), and maintains a record of the usage of the cleat (i.e., the number of times that the cleat has been driven over by a vehicle). In such embodiments, an algorithm within the software can inform the operator that the cleat is wearing out, and has used most or all of its useful life. The software of measurement computer further performs diagnoses of the condition of the vehicle, as will be discussed further herein.

In one embodiment of the present invention, especially for those applications in which the resilient properties of the cleat are known to change as a function of time (such as from environmental degradation due to ozone or other compounds) or as a function of usage, the software can adjust any of the response datasets accordingly. For example, for a cleat that has moderate usage but has not reached the end of its useful life, the software can adjust the data of the specific dataset recorded by a vehicle traversing the partially worn-out cleat to account for resilient material that is more flexible. Alternatively, the software could likewise adjust the baseline or family dataset, and/or adjust the fault index for a degraded cleat.

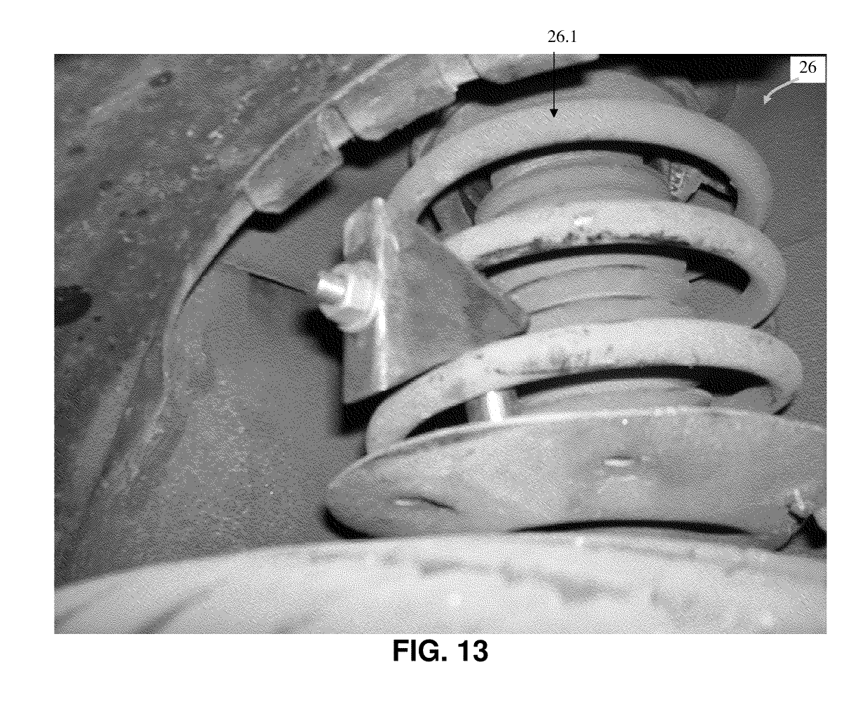

The experiment included of six tests: a first baseline, a simulated suspension fault, three simulated tire faults, and a second baseline. The baseline vehicle had no faults and the pressure in all four tires was 35 psi. The fault in the vehicle suspension was simulated by inserting a metal spacer into the front right coil spring 26.1 of the vehicle 20 as shown in FIG. 13. The three different tire faults were simulated by reducing the pressure of the front right tire to 30 psi, 25 psi, and 20 psi.

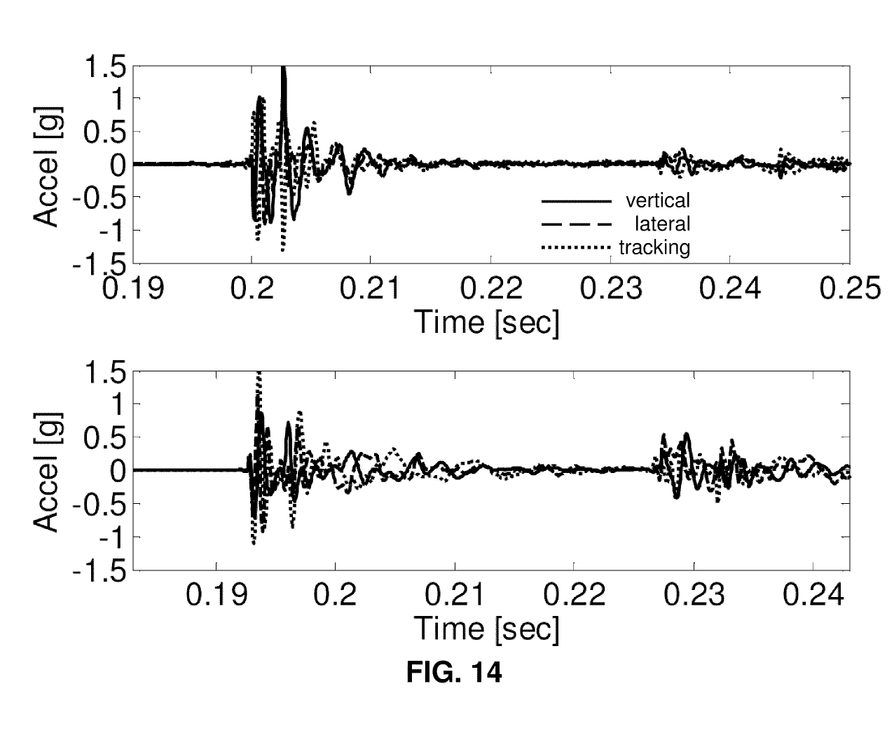

Each test consisted of the vehicle being driven over the instrumented cleat at 5 mph five times and the average accelerations were calculated from the measured data. The data was initially sampled at 16,384 Hz and then down sampled to 819.2 Hz to highlight the lower frequency content that is more indicative of the wheel end and suspension response. FIG. 14 shows the (a) right and (b) left cleat responses in the vertical, lateral, and tracking directions for the first baseline measurement as the front tire traversed the cleat. The time histories observed when the back wheels traversed the cleat were similar. Note that the left cleat measurement was slightly delayed by 70 msec relative to the right cleat measurement. The reason for this delay is that the two tires strike the cleat at slightly different times. The response amplitudes in the three directions were different with a peak acceleration of 1.5 g.

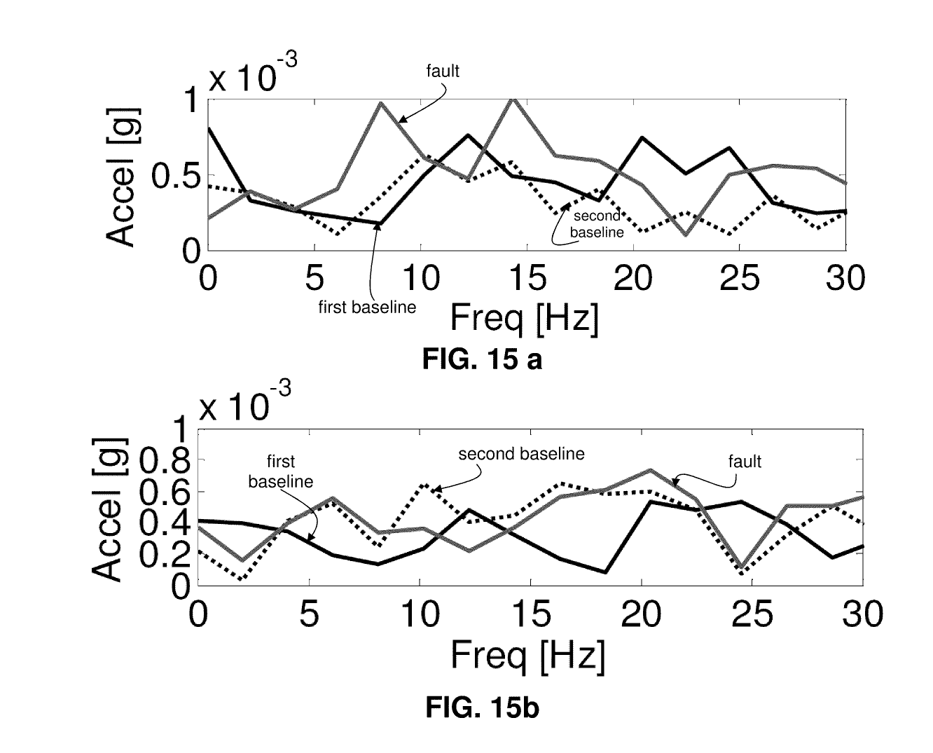

First, the suspension fault simulated as shown in FIG. 13 was considered. FIG. 15 shows the vertical acceleration spectra for the (a) right and (b) left wheels. These plots correspond to the data acquired as the front wheels traversed the cleat. The solid dark and dotted dark lines correspond to the two baseline datasets. The lighter solid line corresponds to the suspension fault dataset. Note that on the top plot for the right wheel in FIG. 15(a), the suspension fault data exhibits two strong peaks at 7.5 and 15 Hz, respectively.

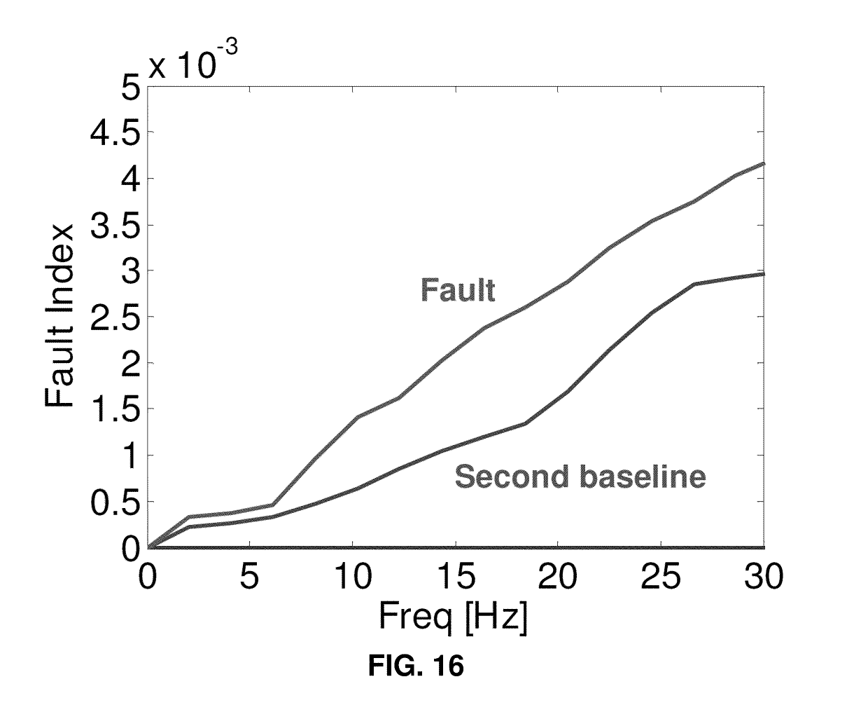

The peak at 7.5 Hz is associated with one of the suspension modes probably at 10 Hz in the other two datasets. The modal peak when the metal spacer is inserted is lower in frequency because by splitting the coil spring of stiffness k into two shorter coil springs of stiffness k, the resultant effective stiffness of the spring is lower, e.g., k/2. The peak at 15 Hz is a second harmonic of 7.5 Hz due to the nonlinear response of the suspension as the spring coils compress on the metal spacer. This behavior was not modeled in the simplified model of FIG. 4; however, nonlinear behavior is expected in the suspension for this type of fault. In contrast, the data in FIG. 15(b) for the left wheel does not exhibit significant differences between the two baseline datasets and the faulty dataset. To quantify these differences, the difference between the second baseline dataset and the first baseline dataset and the difference between the faulty dataset and the first baseline dataset were calculated as a function of frequency. Then the area underneath these two functions were calculated and plotted as a function of frequency. FIG. 16 shows this fault index 88. Note that the faulty dataset exhibits a larger difference from the first baseline dataset than the second baseline dataset. An appropriate threshold would need to be chosen in order to detect the suspension fault using this result.

The fault index 88 is a quantitative measure of the difference between baseline data and data from a specific vehicle under analysis. Baseline data can include response data from the specific vehicle under test, but taken at a time when the vehicle is considered to be an unfaulted configuration, such as when the vehicle left its new build assembly line, when it left as a repaired and rebuilt vehicle from a depot, or even at some point in time after usage of the vehicle began, as examples. In some cases the baseline data is a baseline for a family of vehicles, wherein the term “family” includes vehicles of the same name or part number. When the baseline data includes multiple vehicles, or when it includes multiple data sets from a particular vehicle, then the baseline data can be quantified statistically in terms of high and low response at a particular frequency, for a vehicle being driven at a particular velocity. The present invention further contemplates those embodiments in which the baseline data is simplified to a range of responses at a particular vehicle speed. It is also understood that the present invention contemplates embodiments in which the baseline data is expressed statistically, such as in terms of mean, median, and standard deviation.

The present invention contemplates any manner of fault index in which a dataset from a specific is compared to a baseline dataset. As one example, the baseline dataset and the specific dataset can be analyzed in the frequency domain, such as by means of a transformation of the time-based data with Fourier transformation. As one example, the baseline and specific Fourier components can be compared at any of the known resonant modes of the chassis-suspension system. Further, the fault index can include comparison of frequency components that are not at or near resonant frequencies, such as those that could be induced by a fault in a subframe or frame of the vehicle. Further, the fault index could be prepared in terms of a shift in frequency for a resonant mode.

Yet other embodiments of the present invention contemplate analysis of the fault index in the time domain. As one example, the fault index could be based on a comparison of terms of peak acceleration, peak velocity, peak displacement, peak strain, and the like. Further, the fault index could be based on the comparison of data in the time domain in a particular time window, such as within a window of predetermined time, the window having a beginning based on when the first motion is detected by sensor 60, as one example.

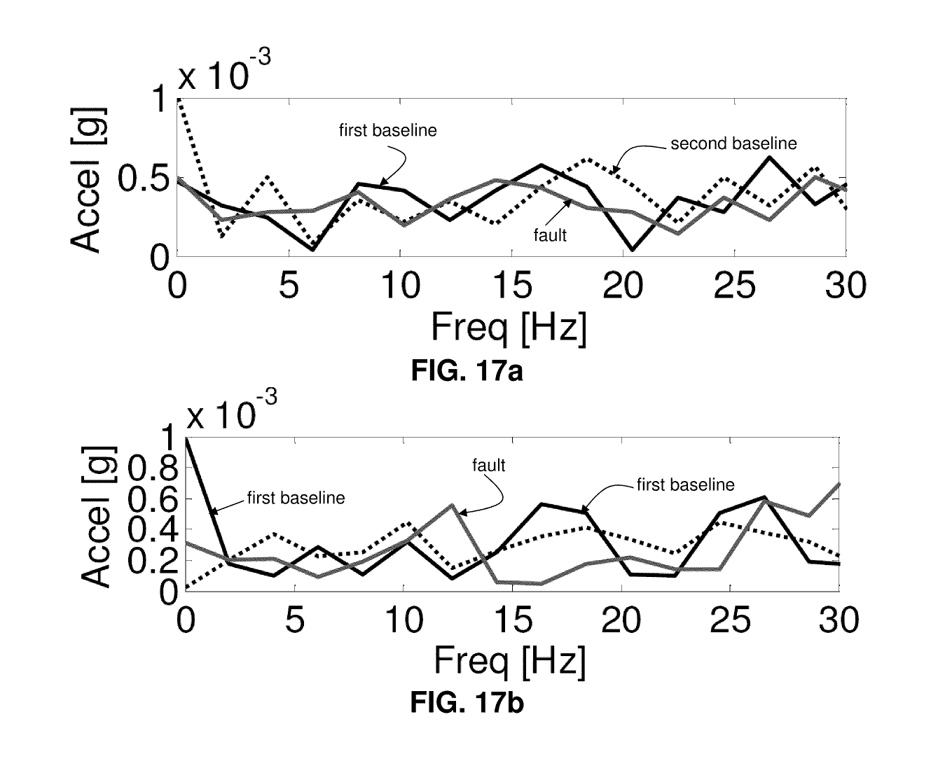

To verify that this approach of FIG. 16 is effective at isolating the fault, the data was also analyzed as the rear wheel traversed the cleat. FIG. 17 shows the comparison of the spectra. Note that now there is no indication that the faulty dataset is significantly different from the baseline datasets. This result verifies that the fault is indeed in the front suspension as opposed to the rear suspension.

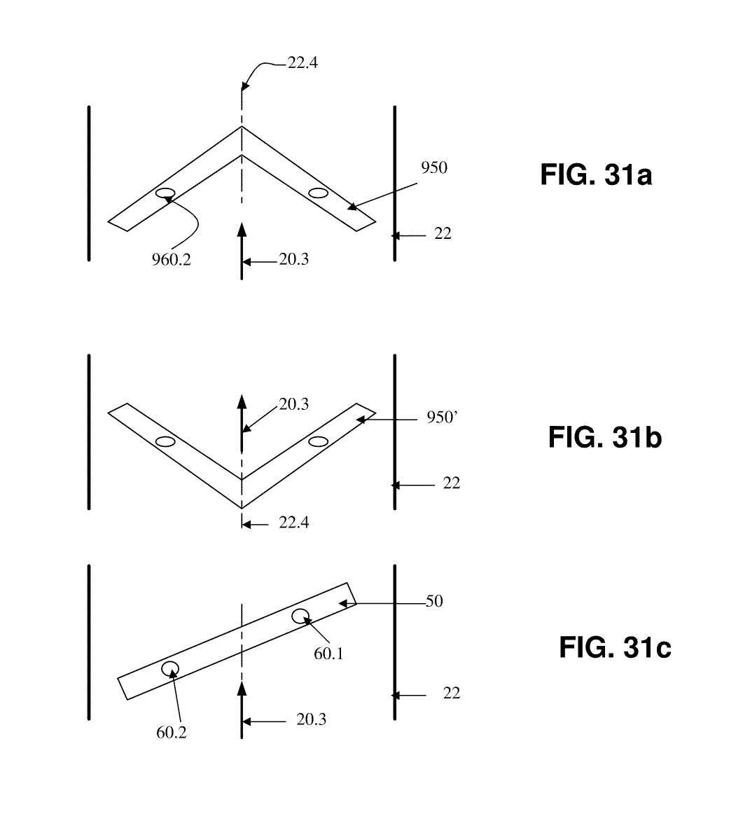

Various other embodiments of the present invention pertain to instrumented cleats that are chevron-shaped or placed at an oblique angle relative to the direction of preferred travel on the roadway. FIG. 31a shows a chevron-shaped cleat 950 located generally along centerline 22.4 of roadway 22. The wheel of a vehicle traveling along a velocity vector 20.3 will encounter the entrance 54.1 to chevron 950 at the outboard edges before the inboard edges of the wheel due to the V-shape. This loading dynamic from outboard toward inboard will place a dynamic compressive load on the front suspension of the vehicle (compression being defined as loading toward the centerline of the vehicle).

FIG. 31b shows roadway 22 with an instrumented cleat 950′ in which the direction of the chevron-shape relative to velocity vector 20.3 is inverted relative to FIG. 31a. In these applications, the inboard edges of the front wheels will be loaded laterally before the outboard edges of the wheels, thus placing a tension load on the suspension relative to the vehicle centerline. The embodiments of FIGS. 31a and 31b can be useful in those situations in which the suspension of vehicle 20 includes laterally-sensitive faults, such as looseness in a spindle retaining nut or in the suspension ball joints.

FIG. 31c shows a cleat 50 oriented on a roadway 22 at an oblique angle relative to centerline 22.4 of the roadway. In this embodiment, it is more likely that vehicle with a velocity vector 20.3 will have the left format wheel ride over the entrance 54.1 to cleat 50 before the right front wheel. Therefore, the maximum response noted at right sensor 60.1 will likely be delayed relative to the response noted at left sensor 60.2. This delay can be attributed to the geometry of the cleat 50 on roadway 22, and can provide an indication of the average velocity of the vehicle as the front suspension rides over cleat 50. Such a velocity measurement based on front wheel impacts can be more accurate than a measurement based on a time delay from front wheels to rear wheels. In some cases, the operator of the vehicle may unintentionally slow down the vehicle after the vehicle front suspension impacts the cleat. In such circumstances, any velocity correction applied to the manipulation of data may be in error in relation to the change in vehicle speed. By instead making the velocity measurement based only on data from the front wheels, the velocity measured over the shorter time period should be more accuracte.

A simplified four degree of freedom model of a HMMWV was developed to study changes in the forces in the tires as a function of faults in the wheels and suspensions. Simulations showed that tire faults were more readily detected than suspension faults at lower frequencies using measured forces in a roadway cleat. Longer cleats were shown to produce data that better separated healthy and faulty wheel end and suspension responses. Tests on a small truck showed that a simulated suspension fault could be detected and isolated to the front right corner of the suspension using an instrumented rubberized cleat to measure tire forces.

FIGS. 30a, 30b, 30c, and 30d show various configurations of roadways and cleats that can be useful in understanding different responses of a particular vehicle, or for understanding different types of vehicles. FIG. 30a shows a curve in a roadway 522, and having a pair of instrumented cleats 350 located at the entrance and exit of the turn. In one embodiment, roadway 522 can be a section of a racing circuit or a skidpath. Cleats 350 are selected for this roadway in order to provide relatively minimal vertical disturbance into the vehicle, yet still achieve a response from the sensors 360 to characterize the dynamic forces exerted by the vehicle on the roadway.

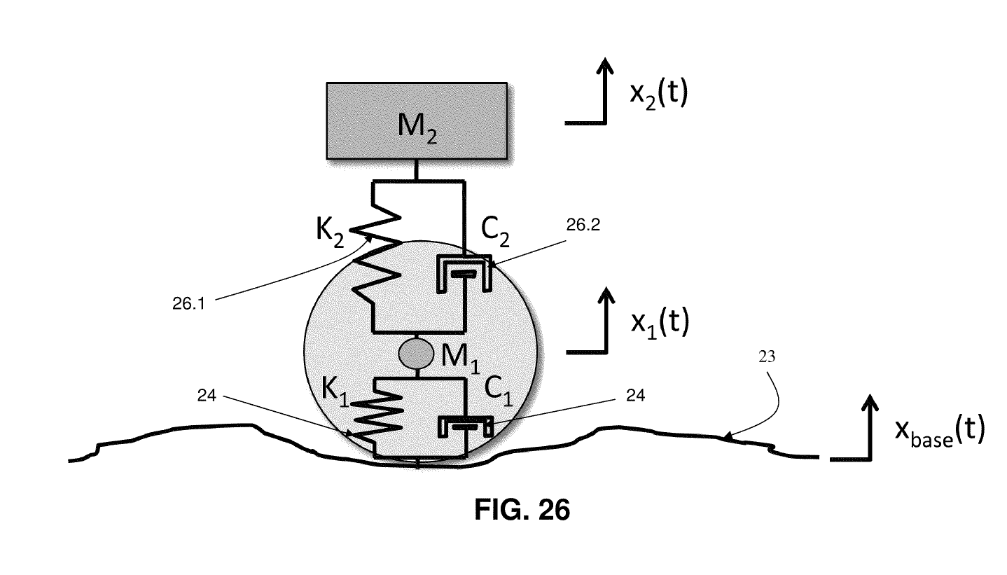

Yet other embodiments of the present invention include multiple patterns of cleats that are adapted and configured to excite one or more of the resonant frequencies of the vehicle system (as determined by analysis of a model as shown in FIG. 4 or 26 or as determined experimentally). FIG. 30b shows a pattern 652 of cleats according to one embodiment of the present invention. Cleats 50 and 150 are spaced apart so as to excite a pitching mode in the vehicle when the vehicle is driven at a particular speed. Further, FIG. 30b shows that various embodiments of the present invention show patterns 52 that include multiple types of cleats.

FIG. 30c shows a roadway 722 having left and right patterns of cleats 750 that are substantially the same, but which are spaced in an alternating pattern. In one embodiment, the spacing between cleats, and the spacing of the left side relative to the right side, are chosen to excite a rolling mode in the vehicle at a predetermined frequency. FIG. 30d shows a roadway 822 having a first pattern 852′ of cleats on the left side of the road, and a second pattern 852″ of cleats on the right side of the road. Pattern 852′ comprises a plurality of cleats spaced apart so as to excite a particular vibratory mode of the vehicle at a predetermined velocity. Pattern 852″ shows a pattern of cleats spaced differently than the first pattern, and adapted and configured to excite a different vibratory mode of the vehicle at the same velocity. The ration of cleat spacings from pattern 852′ to pattern 852″ is the same as ratio of preselected resonant modes of the vehicle.

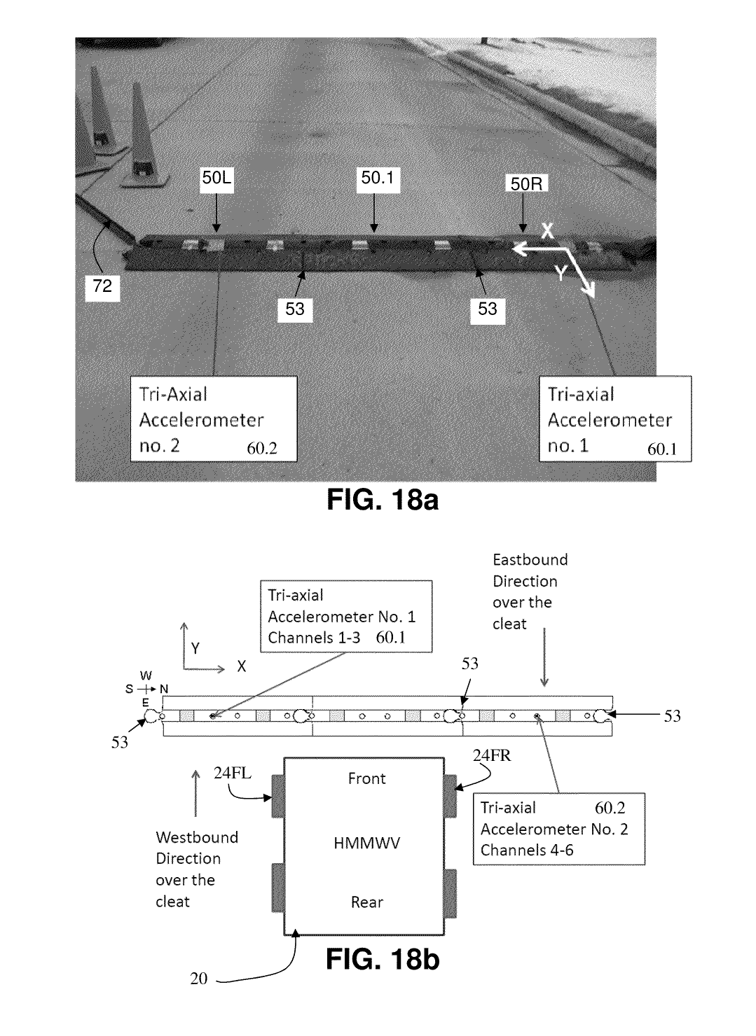

An additional experiment was conducted with one embodiment of the present invention with a rubber cleat 50, which was instrumented with two tri-axial accelerometers (FIG. 18(a)). It is understood that the experimental data described hereafter is by way of example only, and cannot be considered limiting on other embodiments of the present invention. The accelerometers were installed on the medium plane of the cleat on the left and right sides so that the measured accelerations would be sensitive to the left and right tire forces exerted by a HMMWV traversing the cleat. The HMMWV was driven over the cleat multiple times in the East and West bound directions at 5 mph for each set of tests (FIG. 18(b)).

Yet other embodiments of the present invention pertain to a method for calibrating the sensors of an instrumented cleat. Referring to FIG. 18b, it can be seen that as vehicle 20 traverses in the westbound direction over cleat 50, accelerometer #1 will be primarily influenced by loads arising from wheel 24 FL (front left), and accelerometer #2 will be influenced primarily by loads from wheel 24 FR. However, it is possible that accelerometer 60.1 and 60.2 will have slightly different gains of acceleration to electrical charge on the piezoelectric element. In such situations, it is possible to calibrate accelerometer 60.2 relative to accelerometer 60.1 by driving vehicle 20 over the assembly of cleats in both a first direction (westbound as seen in FIG. 18b) and in the other, generally opposite direction (eastbound). In the second test, the response of wheel 24 FR would have primary influence on accelerometer 60.1, and wheel 24 FL would have primary influence on accelerometer 60.2. Therefore, the loading from wheel 24 FR, along with any faults influencing the response of that wheel, will have been measured by both accelerometer 60.1 and accelerometer 60.2. It is possible to correct one or both of the accelerometers to a reference level by assuming that the loading from wheel 24 FR was substantially the same in both cases. In some embodiments, any slight differences in the eastbound velocity as compared to the westbound velocity can also be applied to a respected measurement. Further, it would be possible, in the case where sensors 60.1 and 60.2 are triaxial, to have different calibration factors for each of the different axes of measurement.

The response of a cleat to being driven over by a vehicle depends, at least in part, on the velocity of the vehicle. In terms of the directional component of the vehicle velocity vector, a vehicle driving onto a cleat placed perpendicularly relative to the centerline of the roadway will have its two front wheels ride over the entrance, transition, and exit of the cleat at substantially the same moments in time. However, if the velocity vector is skewed at a non-perpendicular angle relative to the cleat, then one wheel will strike the entrance to the cleat before the other wheel. In situations where the angle of attack is non-perpendicular, it is possible that in some configurations of cleat there could be a traveling wave from one of the sensor locations to the other sensor location that arrives at about the same time as the second sensor is impacted by the vehicle wheel. In some embodiments of the present invention and especially for those cleats in which a traveling wave of non-negligible magnitude can be expected, it may be helpful to detect the traveling wave and apply some type of compensation to affected sensor. In yet other embodiments it may be useful to assume a time delay, calculate compensation, and then review the compensated values to determine the probability of interference with a traveling wave. In yet other embodiments it may be useful to establish the expected range of vehicle velocities such that cross talk effects are minimized.

In yet other embodiments, such as with the cleat shown in FIG. 18a, the presence of information from one sensor in a traveling wave interfering with the other sensor is greatly reduced by the configuration of the cleat itself. FIG. 18a shows a cleat assembly including right and left instrumented cleats 50R and 50L, respectively, interconnected with a non-instrumented segment 50.1. Preferably, cleats 50L, 50.1, and 50R are each fabricated from a resilient compound such as an elastomeric compound. Further, the cleats are interconnected by complimentary connection features 53 (also seen in FIG. 18b). In one embodiment, these interconnection features 53 include a first shape on one side of the cleat, and a second, complimentary-shaped feature on the opposite side of the cleat, such that any number of cleat segments can be interconnected together. Any potential problem with a traveling wave is greatly diminished both by internal damping within the elastomeric material, and further by poor transmissibility across the interlinking features 53.

The additional experiments consisted of five tests: two baselines (initial and final), two simulated suspension faults, and one simulated tire fault. The final baseline test was conducted after all other tests had been completed. The baseline condition consisted of front tire pressures of 20 psi and rear tire pressures of 22 psi. The two suspension faults were simulated by inserting a metal wedge into the front-right and rear left suspension coil springs. The tire pressure test was conducted by reducing the tire pressure in the front-right tire to 14 psi.

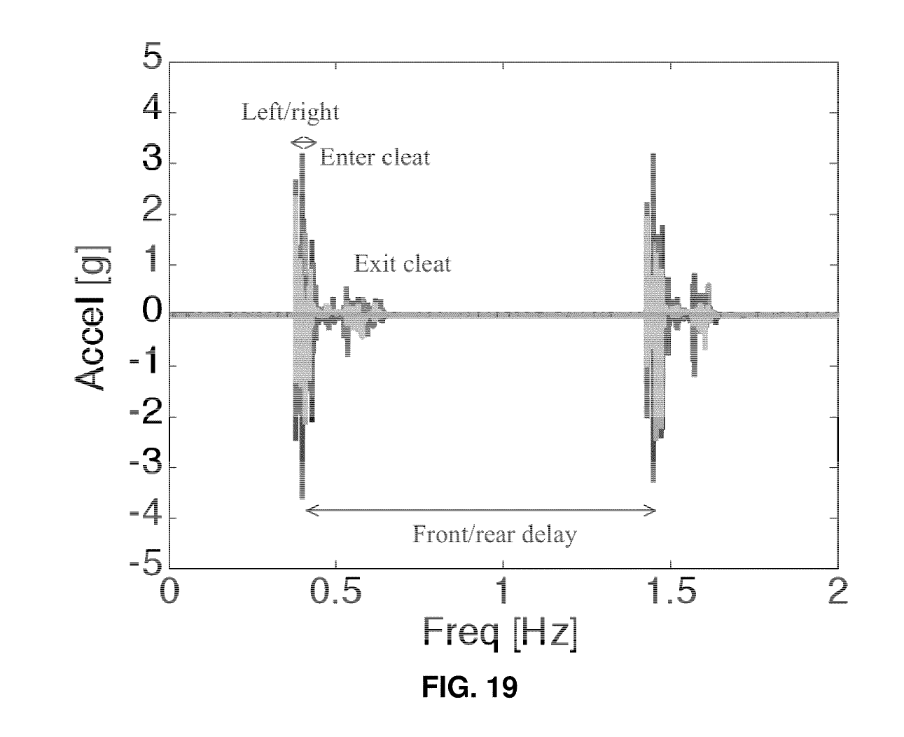

FIG. 19 shows the acceleration measurements in the X, Y, and Z directions for accelerometers 60.1 and 60.2. The acceleration amplitudes are within ±5 g (1 g=9.81 m/s²). Peak levels from both accelerometers are comparable in the X, Y, and Z directions. When the vehicle enters the cleat 50, the largest acceleration amplitudes occur in the Y (vehicle movement/tracking) and Z (vertical) directions due to the forward momentum of the vehicle and the vertical profile of the cleat. The lowest amplitude accelerations occur in the lateral direction (along axis of the cleat). There is a delay between the left and right accelerometer responses due to the cleat's orientation relative to the oncoming vehicle direction. The direction can be determined based on this small delay as described below. If the length between the front and rear wheels is known, the speed of a vehicle can be determined by observing the delay between the front wheel crossing and the rear wheel crossing.

As can be seen in FIGS. 29a and 29b, a cleat 50 according to one embodiment of the present invention has substantially similar entrances and exits for the vehicle wheel. FIG. 29b shows that in other embodiments of the present invention the cleat 150 is asymmetric with regards to entrance and exit. Cleat 50 is largely symmetric about a vertical plane extending midway along transitional portion 54.2. Cleat 150 is asymmetrical in its cross sectional shape. Various embodiments of the present invention contemplate tailoring the entrance 154.1, the transition 154.2, and the exit 154.3 in order to excite particular modes (or to excite particular suspension components) of a family of vehicles.

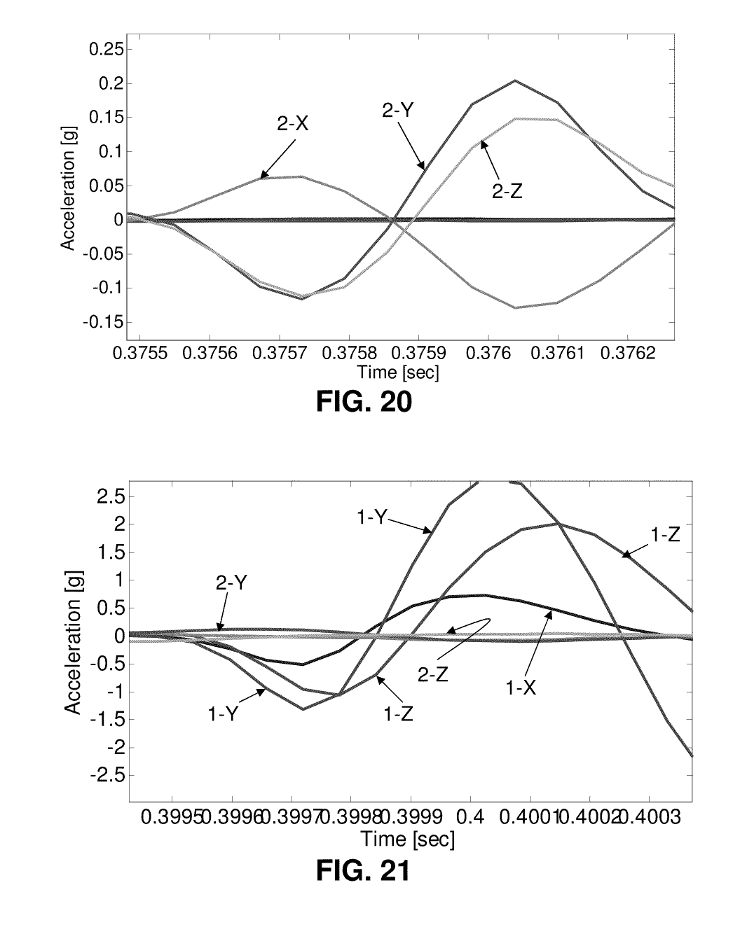

Accelerometer 60.2 is the first to register a response as the vehicle travels in the East bound direction over the cleat 50. The average data acquired across 10 tests for the X, Y, and Z directions of acceleration are plotted in FIG. 20 as the left-front tire begins to traverse the cleat. This data indicates that the Y and Z accelerations are in phase whereas the X acceleration is out of phase with the other two channels as the front left tire travels over the cleat. Specifically, the wheel exerts an outward lateral force (+X) on the cleat in addition to a forward tracking force (−Y) and downward vertical force (−Z). The data indicates that there is little response in accelerometer #1 in this portion of the measurement. This result suggests that there is negligible coupling, or cross-talk, between the two sensors installed within the cleat for this particular measurement. From a data analysis point of view, this low amount of coupling between the two sensorized segments of the instrumented cleat dataset is helpful in enabling diagnosis of fault conditions (left or right wheel).

As the vehicle continues to move forward, accelerometer #1 registers its transient response as shown in FIG. 21. The X, Y, and Z directions of acceleration indicate that all three channels are in phase as the right-front wheel traverses the cleat. The right front wheel pushes laterally outward (−X) on the cleat, forward (−Y) in the direction of vehicle travel, and downward (−Z). These dynamic forces produce negative accelerations in the measured data that is acquired using accelerometer #1. As in the previous set of acceleration measurements, there appears to be little coupling between this measurement of the dynamic response of the cleat due to the forces exerted by the right-front wheel at accelerometer #1 and the measurement at the other side of the cleat in the proximity of accelerometer #2.

These two results taken together suggest that the direction of travel of the vehicle can be determined if the vehicle approach direction is not perpendicular to the line between accelerometers #1 and #2. This ability to determine the direction of travel could be important from an operational perspective. For instance, a vehicle traveling out of the depot could be distinguished from one that is traveling into the depot for service and maintenance using only one cleat based on this approach.

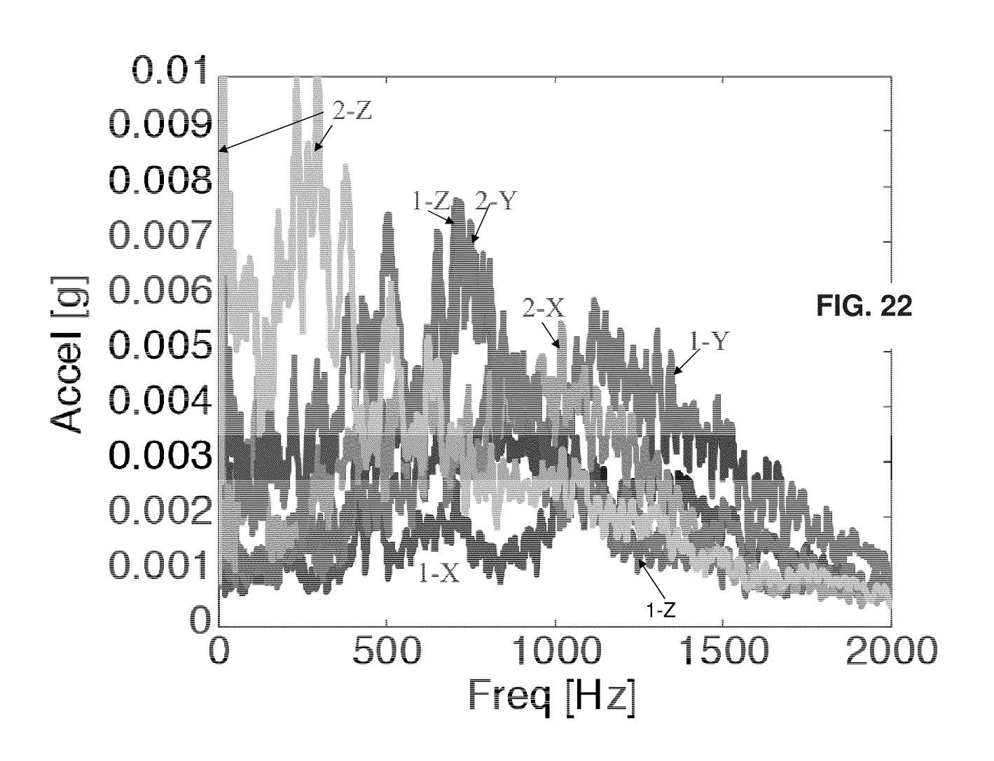

FIG. 22 shows the spectra of the acceleration measurements for the two accelerometers in the initial baseline condition of the vehicle for data that was acquired when only the front wheels traversed the cleat. The largest amplitudes are again exhibited in the two Y and Z direction measurements, whereas the smallest amplitudes are exhibited in the two X direction measurements. The Z direction response for accelerometer #2 is large over the frequency range below 500 Hz. There is clustering in the measured response spectra in certain frequency range below 100 Hz, near 250 and 750 Hz, and again near 1200 Hz. The low frequency response includes increased global suspension (sprung) and wheel (unsprung) dynamic behavior whereas the higher frequency response amplitudes includes increased local dynamic behavior in the tire and suspension components.

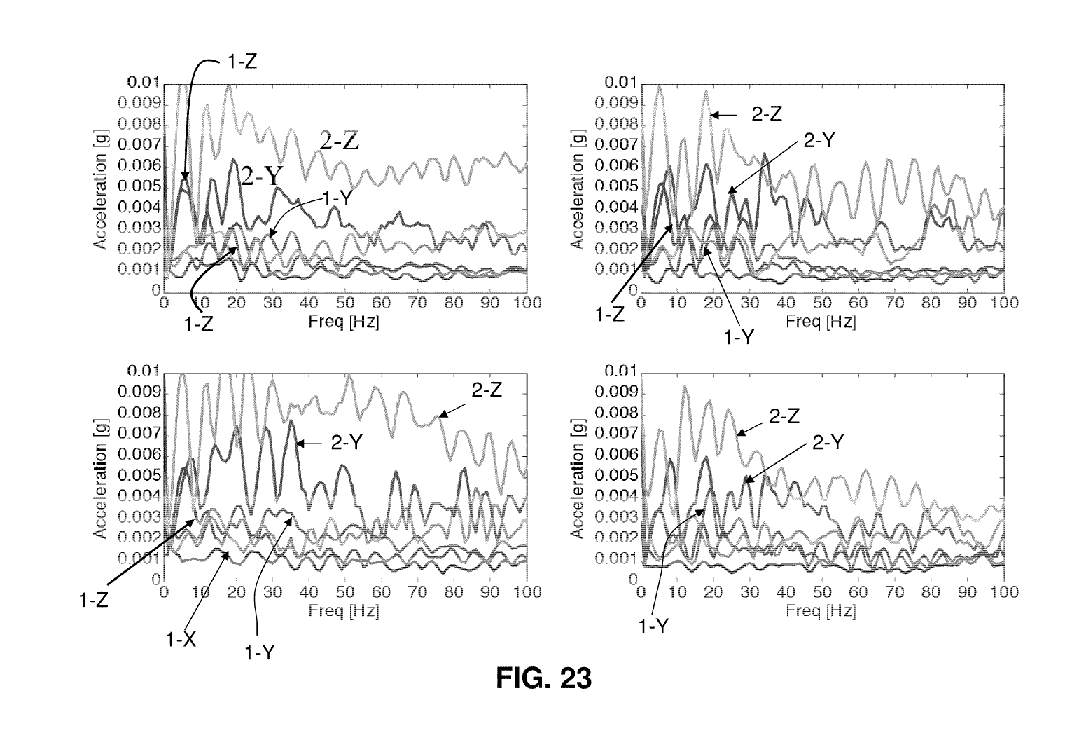

FIG. 23 shows a comparison of the frequency spectra between 0 and 100 Hz for the initial baseline, final baseline, right-front suspension coil fault, and right-front tire pressure fault datasets. The six spectra correspond to the three X, Y, and Z accelerations for accelerometers #1 and #2. Note that the Z direction acceleration response for accelerometer #2 is largest over the entire frequency range and the Y direction acceleration response for accelerometer #2 is second largest as observed in FIG. 22. Due to these differences in the amplitudes of response measured by accelerometers #1 and #2 for an East bound vehicle motion over the cleat, the frequency response functions of the cleat were further analyzed by considering datasets that were acquired for the East bound and West bound motions.

The frequency response function relating a force in the left wheel to the response of accelerometer #2 is denoted by H₂(ω), and the corresponding frequency response function for the right wheel near accelerometer #1 is denoted by H₁(ω). It is assumed that the frequency response functions that relate input forces from the tire footprint to output acceleration responses in the cleat are equal for the vehicle traveling in the East and West bound directions. Given these assumptions, the equations relating the measured accelerations A₁ₑ(ω) and A₂ₑ(ω) for East bound travel and A_{1w}(ω) and A_{2w}(ω) for West bound travel are given by:

A₁ₑ(ω)=H₁(ω)F_{R}(ω)

A₂ₑ(ω)=H₂(ω)F_{L}(ω)

A_{1w}(ω)=H₁(ω)F_{L}(ω)

A_{2w}(ω)=H₂(ω)F_{R}(ω) (7a, b, c, d)

Therefore, the following relationships between the frequency response functions and forces that were estimated on the right and left hand sides of the cleat can be derived:

$$\frac{{A}_{1 e} ( ω ) + {A}_{1 w} ( ω )}{{A}_{2 e} ( ω ) + {A}_{2 w} ( ω )} = \frac{{H}_{1} ( ω )}{{H}_{2} ( ω )} \\ \frac{{A}_{1 e} ( ω ) + {A}_{2 w} ( ω )}{{A}_{2 e} ( ω ) + {A}_{1 w} ( ω )} = \frac{{F}_{R} ( ω )}{{F}_{L} ( ω )} \qquad ( 8 a , b )$$

These formulae were used to calculate and plot the ratios for the left and right hand sides of the cleat to develop insight about the cleat and vehicle symmetry. The initial baseline data for East and West bound directions were used.

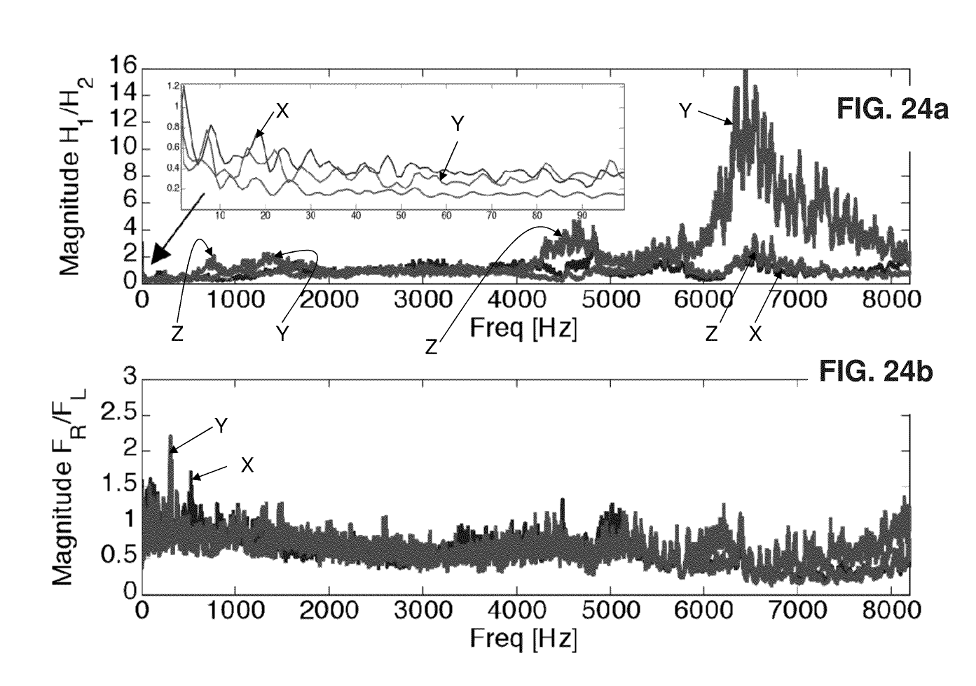

FIG. 24 shows the magnitudes of the (a) frequency response and (b) force ratios as a function of frequency based on the formulae in Eq. (8). The three curves correspond to the ratios for the X, Y, and Z direction measurements. The upper plot indicates that the Z direction response for accelerometer #1 is attenuated relative to the Z direction response for accelerometer #2 in the low frequency range below 100 Hz (see expanded frequency range). This result is consistent with the data in FIG. 23, which showed that the Z direction response was consistently larger in accelerometer #2 than in accelerometer #1 due to the proximity of accelerometer #2 to the path of the wheels.

There is amplification of the Y direction response in accelerometer #1 relative to accelerometer #2 in the 1000-2000 Hz range. The spectra shown in FIG. 23 are consistent with this finding. The ratios of frequency response functions in the range from 2000-4000 Hz are nearly equal to unity suggesting that in this range the cleat filters the wheel forces similarly in this frequency range. Lastly, this frequency response function ratio is primarily a property of the cleat and not a function of the vehicle although there will probably be some dependence on the vehicle. The plot in the bottom of FIG. 24 indicates that the ratio of the left and right tire forces fluctuates around unity.

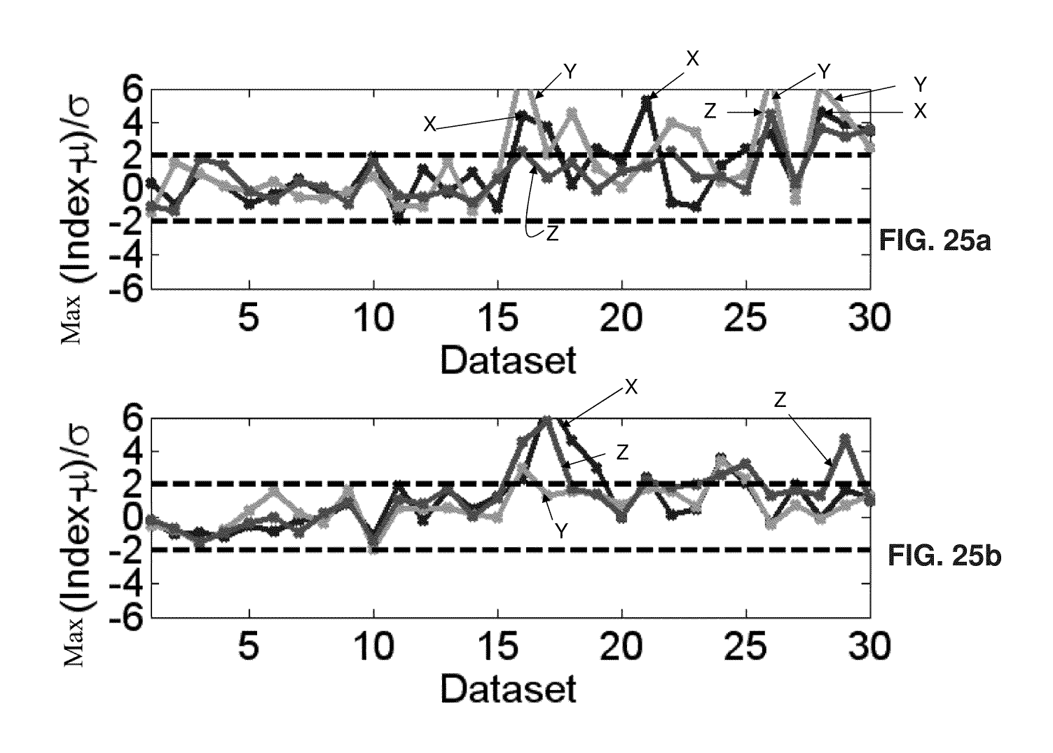

To calculate a fault index, the averaged spectra in the 700-900 Hz range for the ten initial baseline accelerations in the X, Y, and Z directions for accelerometers #1 and #2 as the front wheels traversed the cleat were subtracted from each of thirty comparison datasets as a function of frequency. Then this difference was divided by the standard deviation across the ten initial baseline datasets. Finally, the maximum values of these normalized statistical features were calculated and plotted in FIG. 25 for all thirty datasets. In this example, the fault index is based on a specific response that is greater than or equal to a 2σ variation in this feature, which could indicate a significant deviation in a specific dataset from a family dataset, and due to a fault. The comparison datasets include ten initial baseline datasets, five additional baseline tests, five right-front suspension fault datasets, five left-rear suspension fault datasets, and five right-front tire pressure fault datasets.

The top plot shows the results for accelerometer #1 and the bottom plot shows the results for accelerometer #2. For the first fifteen datasets, which correspond to the initial and final baseline conditions for which there no tire and suspension subsystem faults, there are no deviations outside ±2σ (zero false-positives). For the left-front suspension fault, 4 out of 5 faults are detected by the X, Y, and Z directions using accelerometers #1 and #2. For the left-rear suspension fault, 5/5 faults were detected and for the right-front tire fault, 5/5 faults were detected. Based on the features in FIG. 25(a), it can be concluded that the tire fault is located in the right-front corner

Various embodiments of the inventive cleats discussed herein include one or more axes of measurement. Preferably, an instrumentation package 60 includes one movement sensor oriented in the generally vertical direction, a second movement sensor oriented to detect responses in the generally fore and aft direction and a third movement sensor oriented to detect responses in the lateral direction. However, yet other embodiments of the present invention include only two sensors (such as with vertical and fore and aft orientation).

Yet other embodiments of the present invention contemplate a cleat with a single axis of measurement that is selected to detect certain faults in a vehicle. As one example, a pathway 922 can include first, second, and third instrumented cleats 50X, 50Y, and 50Z. Cleat 50X includes a sensor 60X adapted and configured to detect responses in the X direction. Cleat 50Y includes a sensor 60Y adapted and configured to detect responses in the Y direction. Cleat 50Z includes a sensor 60Z adapted and configured to detect responses in the Z direction. Further, cleats 50X, 50Y, and 50Z may also have cross sectional shapes further optimized to induce responses in the respective dimensions. For example, cleat 50X may be of a chevron-type shape so as to induce lateral responses in the X direction (referring to FIG. 18a for the orientation of axes). Cleat 50Y may have a cross sectional shape adapted and configured to induced responses in the Y or fore and aft direction (such as the relatively shape entrance 154.1 of cleat 150) referring to FIG. 29b. A cleat 50Z may have a cross sectional shape that is adapted and configured to induce vertical response of the vehicle, such as a cleat shaped similar to cleat 50, but including only an entrance 54.1 leading to an exit 54.3, with no transition 54.2 inbetween (referring to a modification of FIG. 29a).

Yet other embodiments of the present invention include calculation of an acceleration vector of maximum magnitude at any instant in time. As one example, the separate three axes of measurement can be combined by use of vector addition to calculate a maximum angle of movement response as well as its orientation (such as in terms of angles of roll, pitch, and yaw, or similarly in terms of azimuth and elevation). By calculating a vector of maximum response as a function of time, errors in the initial alignment of the sensors (such as when the triaxial accelerometer and its attaching cup are inserted into the body of the cleat) can be mathematically removed prior to preparing a fault index. In this manner, the fault index is less susceptible to errors and instrument alignment.

Consider the quarter-car model illustrated in FIG. 26 in this preliminary investigation. In this model, the base excitation, xb(t), acts on the wheel 20, which responds causing displacements, x1(t) and x2(t), of both the unsprung, M1, and sprung, M2, masses, respectively. The associated wheel and suspension mechanical stiffness and damping properties are also denoted in the figure.

In order to estimate the usage of the mechanical elements represented in FIG. 26, and identify any damage contained therein, the model relating the base excitation to the response displacements shown in the figure can be used for two reasons, among others:

(1) The model can be used to estimate the actual inputs to the wheels from the terrain 23 taking into account the complex tire-terrain interactions. These inputs will vary in terms of their amplitudes and frequencies in different missions; therefore, the model can be used to identify these variations.

(2) The model can be used to identify the presence of degradation in the mechanical elements of the system (e.g., K1, C2) directly. Without this model, changes in measured response data can still be calculated, but these changes may merely be due to changes in the input spectrum resulting in false diagnoses of damage to the vehicle.

The model corresponding to the vehicle system model shown in FIG. 26 can be written down explicitly in terms of the input base excitation and the output unsprung and sprung mass displacements as follows (in the frequency domain):

$$[ \begin{matrix}{K}_{1} + {K}_{2} + jω ( {C}_{1} + {C}_{2} ) - {ω}^{2} {M}_{1} & - jω {C}_{2} - {K}_{2} \\ - jω {C}_{2} - {K}_{2} & {K}_{2} + jω {C}_{2} - {ω}^{2} {M}_{2}\end{matrix} ] \{ \begin{matrix}{X}_{1} ( ω ) \\ {X}_{2} ( ω )\end{matrix} \} = \{ \begin{matrix}jω {C}_{1} + {K}_{1} \\ 0\end{matrix} \} {X}_{b} ( ω ) \qquad ( 9 )$$

The impedance matrix on the left hand side of this equation can then be inverted yielding the frequency response function matrix, which relates the base excitation spectrum to the displacement spectra:

$$( 10 a , b , c , d , e )$$

$$\begin{matrix}\{ \begin{matrix}{X}_{1} ( ω ) \\ {X}_{2} ( ω )\end{matrix} \} = {[ \begin{matrix}{K}_{1} + {K}_{2} + jω ( {C}_{1} + {C}_{2} ) - {ω}^{2} {M}_{1} & - jω {C}_{2} - {K}_{2} \\ - jω {C}_{2} - {K}_{2} & {K}_{2} + jω {C}_{2} - {ω}^{2} {M}_{2}\end{matrix} ]}^{- 1} \\ \{ \begin{matrix}jω {C}_{1} + {K}_{1} \\ 0\end{matrix} \} {X}_{b} ( ω ) \\ = \frac{1}{Δ ( ω )} [ \begin{matrix}{K}_{2} + jω {C}_{2} - {ω}^{2} {M}_{2} & jω {C}_{2} + {K}_{2} \\ jω {C}_{2} + {K}_{2} & {K}_{1} + {K}_{2} + jω ( {C}_{1} + {C}_{2} ) - {ω}^{2} {M}_{1}\end{matrix} ] \\ \{ \begin{matrix}jω {C}_{1} + {K}_{1} \\ 0\end{matrix} \} {X}_{b} ( ω ) \\ = \frac{1}{Δ ( ω )} \{ \begin{matrix}( {K}_{2} + jω {C}_{2} - {ω}^{2} {M}_{2} ) ( jω {C}_{1} + {K}_{1} ) \\ ( jω {C}_{2} + {K}_{2} ) ( jω {C}_{1} + {K}_{1} )\end{matrix} \} {X}_{b} ( ω ) \\ = \{ \begin{matrix}{H}_{1 , b} ( ω ) \\ {H}_{2 , b} ( ω )\end{matrix} \} {X}_{b} ( ω )\end{matrix} where$$

$$Δ ( ω ) = ( {K}_{1} + {K}_{2} + jω ( {C}_{1} + {C}_{2} ) - {ω}^{2} {M}_{1} ) ( {K}_{2} + jω {C}_{2} - {ω}^{2} {M}_{2} ) - {( jω {C}_{2} + {K}_{2} )}^{2}$$

Eq. 10(d) is the dynamic model for the quarter-car model relating the input base excitation spectrum to the output displacement spectra. If all of the mass, damping, and stiffness parameters were known a priori, this model could be constructed and then used as described above for estimating vehicle usage and damage. However, the parameters vary for a number of reasons including varying payloads, vehicle-to-vehicle differences, etc.

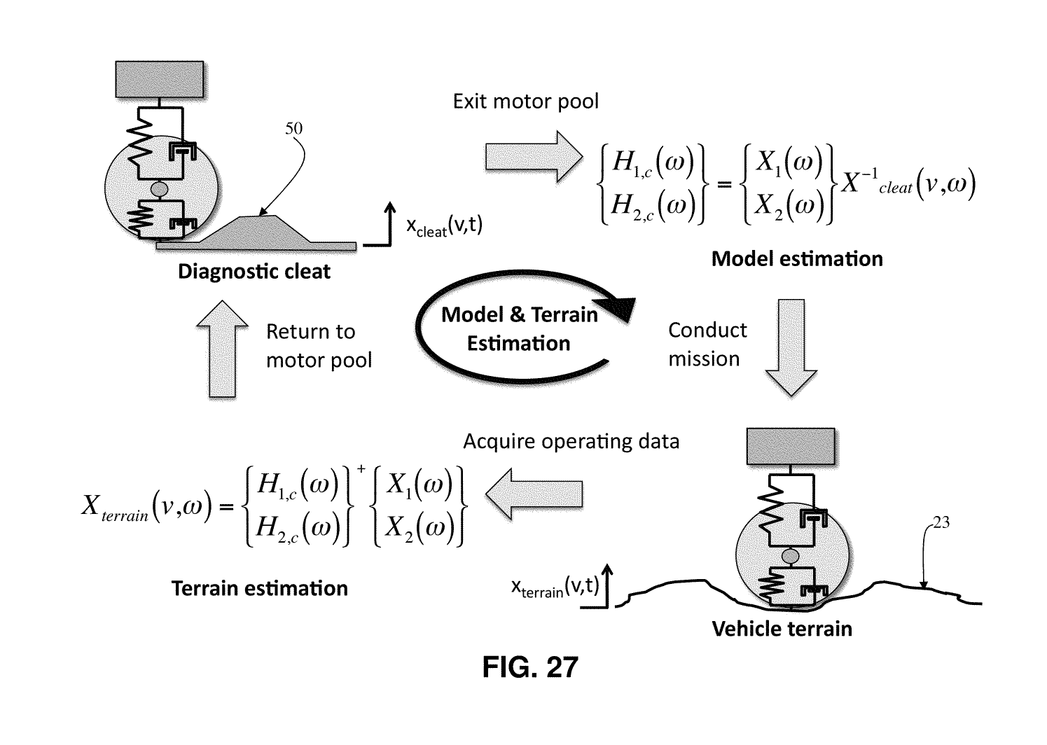

Because of these variations, a model identification process can be used in the field to estimate the frequency response functions in Eq. 10(d). FIG. 27 shows the process by which these functions can be estimated using the diagnostic cleat. In this figure, the vehicle 20 is shown traversing the diagnostic cleat 50, which has a prescribed displacement profile as a function of time based on the vehicle speed. When the vehicle travels over the cleat, the displacements of the unsprung and sprung masses respond accordingly. These measurements are then combined with the known cleat spectrum to estimate the unknown frequency response functions. The subscript “c” is used to denote that the frequency response functions were estimated given the cleat input.

Once the two frequency response functions are estimated in this simplified model as the vehicle exits the motor pool, the vehicle then deploys on a mission. On this mission, the vehicle traverses various terrains 23, which exercise the vehicle 20 differently depending on the vehicle speed and terrain profile. On-board sensors 27 record the operational unsprung and sprung mass displacements (accelerations), and then measurements are fed into the inverse model shown in the bottom left portion of FIG. 27. The on board sensors 27 can be those of any type that provide information regarding the movement X₂(t) (refer to FIG. 26) of the vehicle, and can be of any type with sufficient frequency response, including accelerometers, velocity sensors, displacement sensors, strain gages (especially those cases in which the measured strain can be related to movement of the vehicle mass (M₂). The subscript “+” is used to denote a pseudoinverse operation, which is tantamount to a dot product between the two vectors indicated in the figure. This operation is used to minimize the sum of the squared errors across the two equations in the model of the quarter-car to estimate the terrain input spectrum.

When the vehicle returns to the motor pool, the diagnostic cleat 50 can again be used not only to inspect the vehicle for possible faults based on the model obtained when the vehicle exited the motor pool, but the cleat can also be used to update the frequency response function model. In this way, the cleat measurements are combined with the on-board operational measurements to carry out a continuous process of model identification and terrain estimation.

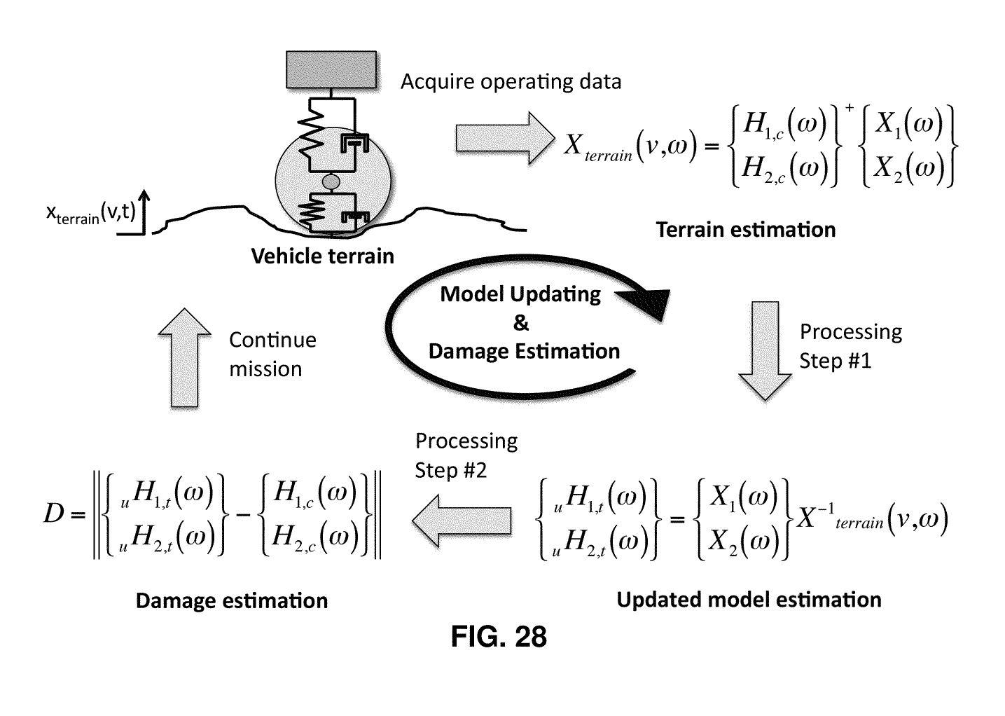

Additional information can also be gleaned from the operational field data as shown in FIG. 28. The frequency response function model of the quarter-car vehicle can be used to estimate the terrain encountered by the vehicle on its mission. Furthermore, if any components such as the strut, suspension tie bolt, etc. degrade over the course of the mission, the errors that are minimized across the two equations that enter the least-squares calculation (bottom left of FIG. 27) will increase in magnitude. This increase in the modeling error can be extracted using a model updating process to estimate the location and amount of degradation experienced by the vehicle components. FIG. 28 illustrates this model updating and damage estimation process. After the vehicle traverses the terrain and the terrain input spectrum is estimated, the resultant estimate can then be used to solve yet another inverse problem as shown in the bottom right of FIG. 28. Essentially, this operation distributes the error in the model to the portions of the model (wheel, suspension) that are most likely damaged. In the bottom left of FIG. 28 a fault index, D, is calculated by taking the Euclidean norm of the difference between the original model developed using the cleat upon deployment and the updated model developed using the terrain input. The magnitude of this fault index is an indication of damage to this corner of the vehicle. Alternatively, the magnitude of each entry of this difference vector could also be used to localize the degradation (if there is any) in the corner.

In this manner described above for various embodiments, damage to the vehicle can be identified in addition to the terrains encountered by the vehicle to provide additional information for maintaining the vehicle when it returns to the depot.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

1. A method for analyzing a vehicle, comprising:
providing a roadway including a localized elevational change comprising at least one of a bump or trough, a sensor located in the roadway and proximate to the elevational change, and a vehicle having a wheel;
driving the vehicle such that the wheel rides over the elevational change;
preparing a first dataset of the response of the sensor to said driving;
operating the vehicle for a period of time after said driving;
redriving the vehicle such that the wheel rides over the elevational change after said operating;
preparing a second dataset of the response of the sensor to said redriving; and
comparing the second dataset to the first dataset.

2. The method of claim 1 wherein said driving is within a range of predetermined velocities, and said redriving is within the range of predetermined velocities.

3. The method of claim 1 wherein said driving is at a first velocity, said redriving is at a second velocity different than the first velocity, and which further comprises modifying one of the first dataset or the second dataset to account for the difference between the first velocity and the second velocity.

4. The method of claim 1 which further comprises determining changes in the condition of the vehicle by said comparing.

5. The method of claim 4 wherein the wheel is coupled to the vehicle by a suspension, and said determining is of changes in the suspension or the wheel.

6. The method of claim 1 wherein the sensor is an accelerometer.

7. The method of claim 6 wherein the first dataset and the second data set are each expressed in the frequency domain.

8. The method of claim 1 wherein the sensor is a multiaxis accelerometer.

9. The method of claim 8 wherein the first dataset and the second dataset each include maximum acceleration calculated by vector addition of the multi-axis measurements.

10. The method of claim 1 wherein the elevational change is resilient and the sensor is embedded in the elevational change.

11. The method of claim 1 wherein the vehicle has first and second front wheels, and which further comprises:
arranging the elevational change on the roadway at an oblique angle relative to the centerline of the roadway;
measuring a time delay with the sensor from the first wheel driving over the elevational change to the second wheel driving over the elevational change; and
calculating the velocity of the vehicle during said redriving from the time delay.

12. A system for analyzing a wheeled vehicle driven on a roadway, comprising:
a portable segment of driving surface, said portable segment having a bottom side adapted and configured to be placed on the roadway and a top side adapted and configured for supporting a wheel of the driven vehicle, said portable segment having a cross-sectional shape for changing the elevation of the driven surface;
a sensor located within said portable segment, said sensor providing a signal corresponding to movement of said portable segment; and
a computer having software and receiving said signal, said software including a predetermined dataset;
wherein said software compares the signal to the predetermined dataset.

13. The system of claim 12 wherein said sensor provides a signal corresponding to acceleration within said segment.

14. The system of claim 12 wherein said sensor provides a signal corresponding to strain within said segment.

15. The system of claim 12 wherein said sensor provides a signal corresponding to velocity within said segment.

16. The system of claim 12 wherein said sensor provides a signal corresponding to displacement within said segment.

17. The system of claim 12 wherein the predetermined dataset includes data for a vehicle driven over the same cross-sectional shape.

18. The system of claim 12 wherein the cross sectional shape is a truncated triangle.

19. The system of claim 12 wherein said segment is fabricated from an elastomeric material.

20. The system of claim 12 wherein said segment has a chevron shape as viewed from above.

21. The system of claim 12 wherein said segment has an elongated planform shape, the roadway has a centerline, and said segment is placed on the roadway at an oblique angle relative to the centerline.

22. An apparatus for a vehicular roadway, comprising:
a portable segment of driving surface, said segment having a bottom side adapted and configured to be placed on the surface of a roadway, said segment having a top surface adapted and configured to be driven on by a wheeled vehicle, said segment having a cross-sectional shape adapted and configured to locally elevate a vehicle driven over said segment, said segment being sufficiently flexible to generally conform to the surface of the roadway; and
at least two movement sensors located within said portable segment, each of said movement sensors providing a signal corresponding to one of displacement along a direction, velocity along a direction, or acceleration along a direction, the direction of each said sensor being aligned to provide a signal that is at least partly orthogonal to the direction of the signal of the other said sensor.

23. The apparatus of claim 22 which further comprises a plurality of said portable segments each including at least two movement sensors, said segments each having a length and placement on the roadway such that only one wheel of a front pair of wheels of the vehicle traverses a segment at one time.

24. The apparatus of claim 22 which further comprises a plurality of said portable segments each including at least two movement sensors, said segments being arranged in a first group each spaced apart a first distance from one another along the left side of the roadway and a second group each spaced apart a second distance from one another along the right side of the roadway.

25. The apparatus of claim 24 wherein the first distance is the same as the second distance.

26. The apparatus of claim 24 wherein the vehicle has a first frequency of oscillation, and the first distance is selected to excite the driven vehicle at the first frequency.

27. The apparatus of claim 24 wherein the first distance is different than the second distance.

28. The apparatus of claim 24 wherein the vehicle has a first mode of oscillation at a first frequency, a second mode of oscillation different than the first mode at a second frequency, the first distance is selected to excite the driven vehicle at the first mode, and the second distance is selected to excite the driven vehicle at the second mode.

29. The apparatus of claim 22 wherein the cross-sectional shape has a vertical plane of symmetry.

30. The apparatus of claim 22 wherein the bottom side is substantially flat, said segment has a leading edge and a trailing edge and the cross-sectional shape increases to a maximum thickness intermediate of the leading and trailing edges.

31. The apparatus of claim 22 wherein said portable segment is fabricated from an elastomeric material.

32.-48. (canceled)

49. A method for testing a vehicle, comprising:
providing a portable resilient elevational change including a pair of spaced apart movement sensors and a wheeled vehicle;
placing the elevational change on a roadway;
driving the vehicle over the change in a first direction;
recording first data from each sensor during said driving;
redriving the vehicle over the change in a second direction generally opposite to the first direction;
recording second data from each sensor during said redriving; and
comparing the first data to the second data.

50. The method of claim 49 wherein said first driving and said second driving are at substantially the same speed.

51. The method of claim 49 which further comprises measuring the speed of the vehicle during said driving and during said redriving, modifying the first data based on the speed during said driving, and modifying the second data based on the speed during said redriving.

52. (canceled)

53. The method of claim 49 wherein the movement sensors are accelerometers.

54. The method of claim 49 wherein each of said movement sensors are multiaxial and measure data along at least two axes.

55. The method of claim 54 wherein said comparing includes calculating a vector of maximum magnitude from the multiaxial data of the sensors.

56.-67. (canceled)

68. The system of claim 12 wherein said segment has a serial number, the serial number is stored in said software, and said software records the number of events in which a vehicle has been driven over said segment.

69. The system of claim 68 wherein said software applies a correction to data from the signal based on the number of events.

70. The system of claim 68 wherein said software provides an indication of the remaining life of said segment based on the number of events.

71. (canceled)

72. The method of claim 49 wherein the first data and the second data include acceleration as a function of frequency, and said comparing is dividing the first data by the second data.

73. The method of claim 49 wherein the first data and the second data include acceleration as a function of frequency, and said comparing is subtracting the first data from the second data.

74. The method of claim 49 wherein the sensors are first and second sensors, and said comparing is of the first data of the first sensor with the second data of the first sensor.

75. The method of claim 74 wherein the first data and the second data include acceleration as a function of frequency.

76. The method of claim 74 wherein the first data and the second data include peak responses from the first and second sensors.

77. The method of claim 74 wherein the first data and the second data include average responses from the first and second sensors.

78.-82. (canceled)
